(19) United States
(12) Patent Application Publication
(10) Pub. No.: US 2004/0107010 A1
(43) Pub. Date: Jun. 3, 2004

(54) Planning support system and method

(76) Inventor: William A. King, Virginia Beach, VA (US)

Correspondence Address: Raymond Jones, Esq., IP Law Global, P.C., Suite 550 - PMB 5537, 11921 Freedom Drive, Reston, VA, 20190, US

(21) Appl. No.: 10/637,649

(22) Filed: Aug. 11, 2003

Related U.S. Application Data
(60) Provisional application No. 60/402,545, filed on Aug. 12, 2002.

(51) Int. Cl. G05B 11/01; G05B 13/02; G05B 15/00

(52) U.S. Cl. 700/17; 700/83; 700/30; 700/31

(57) ABSTRACT

A planning support system and method implemented in a computer system having a core control bridge communicating between a database and a user interface. The core control bridge receives user inputs from the user interface in accordance with criteria specified by a pre-existing planning model stored in the database. The information from the user inputs is processed in accordance with the criteria of the pre-existing planning model. Export file formats are generated for exporting information, the information being determined by interaction between the user inputs and the criteria of the pre-existing planning model. The resulting information is then exported into commercially available word processing, graphics, and presentation software, or customized software applications as determined by a client. The system and method can be adapted to any customized or commercial export file format, and well as exports to computers with different operating systems.

### RELATED APPLICATIONS

This application claims priority from U.S. Provisional Patent Application No. 60/402,545 filed Aug. 12, 2002, which is hereby incorporated by reference in its entirely.

### BACKGROUND OF THE INVENTION

1. Field of the Invention

The present invention relates to a system and method for providing a structured approach to planning in either a stand-alone or collaborative manner, which can support a wide variety of planning models/situations as well as interface with a wide variety of computer software, hardware and operating systems.

2. Description of Related Art

Most organizations require the capability to efficiently and productively plan and coordinate the employment of manpower, materials, and other resources in a variety of ever changing environments, up to and including times of crisis. Unfortunately, resource management is frequently inadequate, owing to the lack of a formal planning paradigm or training. Often, the responsibility to plan in these varying situations is delegated to individuals with insufficient planning experience and few, if any, automated tools to assist in the overall planning effort.

Accordingly, a need exits for a disciplined, structured approach to planning that enables collaboration among requisite members and uses automated planning tools proven successful even in the most volatile of conditions.

### SUMMARY OF THE INVENTION

By using the planning support system and method of the present invention, what seems to be totally disjointed information is structured, refined, entered into an automated medium, and applied to organizational decision-making, task accomplishment, or resource management.

This same planning support model can disseminate decisions and other information, forecast reaction to future events, provide updates to all levels of the organizational and to the customer base, and interface with other media to improve organizational efficiency and increase overall effectiveness. The present invention finds applicability throughout the commercial, government, and military sectors.

The present invention responds to recognized organizational requirements with tailored support for all planning situations. The present invention is not specific to a single hardware system, software family, or operating system. Rather, it is adaptable to the specific preferences of the end user.

To achieve these and other objects, the present invention provides a planning support system and method implemented in a computer system having at least a core control bridge communicating between a database and a user interface. The core control bridge receives user inputs from the user interface in accordance with criteria specified by a pre-existing planning model stored on a file system or in a database. The information from the user inputs is processed in accordance with the criteria of the pre-existing planning model. Export file formats are generated for exporting information based on the criteria of the pre-existing planning model. The resulting information is then exported into commercially available word processing, graphics, and presentation software, or customized software applications as determined by a client. The system and method can be adapted to any customized or commercial export file format, and well as provide export file formats compatible with different operating systems.

### BRIEF DESCRIPTION OF THE DRAWINGS

The above objects and other advantages of the present invention will become more apparent by describing in detail the preferred embodiments thereof with reference to the attached drawings in which:

FIG. 1 is a chart graphically depicting an anticipated scope of a planning event/model;

FIG. 2 is a chart graphically depicting an anticipated focus of a planning event/model;

FIG. 3 is a chart graphically depicting an anticipated time of a planning event/model;

FIG. 4 is a chart graphically depicting an anticipated scale of a planning event/model;

FIG. 5 is a chart graphically depicting a complete planning matrix of a planning event/model;

FIG. 6 is a schematic diagram of the main components of an embodiment of the present invention;

FIG. 7 is a schematic diagram of the main components of an embodiment of the present invention in stand-alone mode;

FIG. 8 is a schematic diagram of the main components of an embodiment of the present invention in network mode;

FIG. 9 is a sample log-in window for the network mode or stand-alone mode;

FIG. 10 is a sample database user account page;

FIG. 11 is a schematic diagram of a network configuration including a core control bridge module on each user workstation sharing a centralized database;

FIG. 12 is a schematic diagram of a network configuration including a core control bridge module on a centralized server being shared by a variety of users;

FIG. 13 is a schematic diagram of a network configuration including two core control bridges interacting with a single database loaded on one of the servers;

FIG. 14 is a schematic diagram of a user interface with a menu driven presentation;

FIG. 15 is an exemplary main menu screen of a planning model generated on the user interface;

FIG. 16 is an exemplary sub-menu screen within the menu of FIG. 15;

FIG. 17 is an exemplary sub-form entry screen within the sub-menu of FIG. 16;

FIG. 18 is an exemplary dialog box entry screen within the sub-menu of FIG. 16;

FIG. 19 is an example screen of data imported from a web site;

FIG. 20 is an exemplary navigation bar for moving between screens of the user interface;

FIG. 21 is a schematic diagram of interaction between the core control bridge and the database;

FIG. 22 is an exemplary query screen within a sub-menu;

FIG. 23 is a schematic diagram of interaction between the core control bridge and export applications;

FIG. 24 is a schematic diagram of interaction between the core control bridge and a file format;

FIG. 25 is a schematic diagram of interaction between the core control bridge and other hardware;

FIG. 26 is a exemplary database plans table;

FIG. 27 is a chart graphically depicting an exemplary planning matrix of a planning event;

FIG. 28 is an exemplary title screen for the planning event of FIG. 27;

FIG. 29 is an exemplary cover-acknowledgements screen for the planning event of FIG. 27;

FIG. 30 is an exemplary log-in form for the planning event of FIG. 27;

FIG. 31 is an exemplary main menu screen for the planning event of FIG. 27;

FIG. 32 is an exemplary initial configuration screen for the planning event of FIG. 27;

FIG. 33 is an exemplary users accounts screen for the planning event of FIG. 27;

FIG. 34 is an exemplary new plan screen for the planning event of FIG. 27;

FIG. 35 is an exemplary current plan screen for the planning event of FIG. 27;

FIG. 36 is an exemplary planning menu screen for the planning event of FIG. 27;

FIG. 37 is an exemplary mission statement screen for the planning event of FIG. 27;

FIG. 38 is an exemplary sub-menu button for the planning event of FIG. 27;

FIG. 39 depicts alternate exemplary sub-menu buttons for the planning event of FIG. 27;

FIG. 40 depicts exemplary buttons for generating a mission statement;

FIG. 41 is an exemplary briefing menu screen;

FIG. 42 is an exemplary decision brief menu screen;

FIG. 43 is an exemplary directives menu screen;

FIG. 44 is an exemplary evacuation directive menu screen;

FIGS. 45A-45F are a flow diagram illustrating an operational embodiment of the core control bridge for creating a new plan and the interaction between the user, the core control bridge and the database;

FIGS. 46A-46C are a flow diagram depicting an exemplary interaction between the user, the core control bridge and the database for data input; and

FIGS. 47A-47B are a flow diagram depicting an exemplary interaction between the user, the core control bridge and the database to create an external application.

### DETAILED DESCRIPTION OF PREFERRED EMBODIMENTS

The present invention will now be described more fully with reference to the accompanying drawings, in which preferred embodiments of the invention are shown. The invention may, however, be embodied in many different forms and should not be construed as being limited to the embodiments set forth herein. Rather, the embodiments are provided so that this disclosure will be thorough and complete, and will fully convey the concept of the invention to those skilled in the art.

Broadly described, the invention is designed to provide a disciplined approach to planning in a stand-alone or collaborative manner and to support a wide variety of planning models and situations. The invention can also interface with a wide variety of computer software, hardware and operating systems.

The invention comprises a core control bridge that is adaptable to follow any planning model used by the customer and takes information developed in their planning process to construct briefings, directives, or other client-based reporting or information dissemination requirements.

The invention is not limited to a specific model or type of computer hardware or peripheral equipment, and can operate with a variety of other non-computer hardware such as telecommunications equipment and recording devices. The invention is designed for either the single user or multiple users in a collaborative environment and functions in both a stand-alone mode or as part of a computer network. This network arrangement can be an organizational intranet, the Internet, or a combination of the two.

The invention is not limited to one specific platform application or software application family, and is capable of operating within the parameters of the user's current and anticipated software requirements.

Further, the invention is not limited to one specific platform or operating system, and is capable of functioning on all existing operating systems and can be modified to meet future operating system innovations.

Planning as described herein generally refers to a continuous process to enhance organizational decision-making, achieve established goals or objectives, accomplish designated tasks, manipulate future events, or the like.

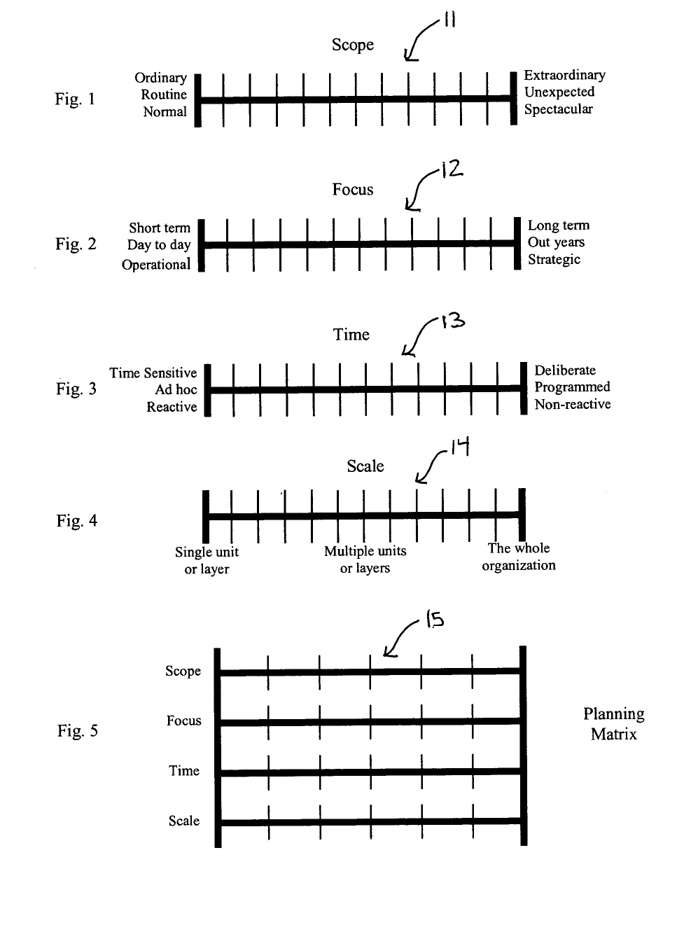

Referring generally to FIGS. 1-4, a planning event/model is typically classified through the use of a matrix composed of four specific components common to all planning environments, namely, scope, focus, time and scale.

In FIG. 1, the scope 11 of the planning refers to the degree of normalcy associated with the planning event. This aspect of the planning environment ranges from situations that are regular or routine in nature to those associated with extraordinary, unexpected, or spectacular events and circumstances.

In FIG. 2, the focus 12 is defined as that point in the organizational calendar where the results of the planning event are directed. One end of the focus spectrum is planning that is conducted to support day-to-day or short-term requirements. This planning is generally operational in nature with an action orientation. At the other end of the spectrum are planning events conducted for the long term; in some cases, years in the future. This planning is described as strategic in nature with a visionary or goal orientation.

In FIG. 3, the time component 13 refers to the period of time available between the start of the planning event and expected execution of the completed plan. This time span may range from ad hoc or reactive situations, where time is critical, to situations where time is not a significant variable and the planning is deliberate in nature.

In FIG. 4, the final characteristic of scale 14 is indicative of the number of layers in the organization involved in the overall planning effort. The scale of effort covers the spectrum from a single unit or layer through multiple units and layers to planning involving the entire organization.

By combining all four of these components, a single matrix 15 or descriptive tool can be fashioned to provide a visual description of any planning model as shown in FIG. 5. The invention is capable of supporting all possible combinations of these four components in any of the planning scenarios identified in the definition.

The invention has applicability in the planning efforts in commercial, government, or military organizations. The customer base for the invention includes but is not limited to:

Corporations and other for profit organizations and agencies.

Federal government, federal organizations, and agencies.

State government, state organizations, and agencies.

Local, regional, city, county governments, organizations, and agencies.

Non-governmental organizations and agencies to include public and non-profit organizations and agencies.

Joint United States military organizations and agencies, individual services, other military organizations and agencies, reserve organizations and agencies, and the National Guard.

Designated foreign corporations, militaries, or other foreign organizations and agencies.

A more detailed description of the components of the invention will now be provided.

Core Control Bridge Overview

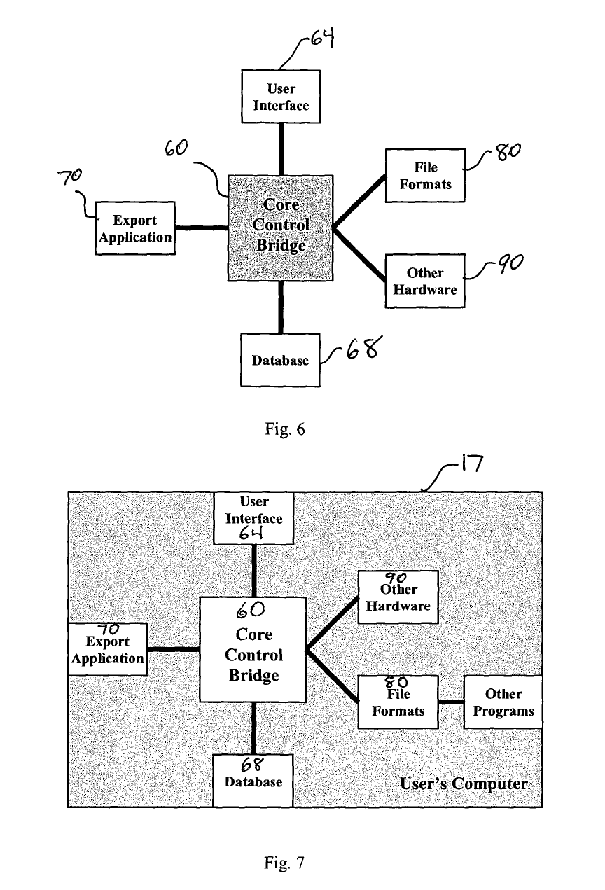

In FIG. 6, the core control bridge 60 (“CCB”) provides the necessary link between a user interface 64 and a database 68. The CCB 60 also provides the necessary connectivity with a variety of export applications 70, generates specialized file formats 80 to interoperate with other software programs or computer systems, and provides the connectivity to other hardware and networked systems 90, all in support of the user's overall planning efforts

The CCB 60 is composed of modular code written to support the explicit functions of the overall system. A specific component of the CCB 60 can use commercial off the shelf technology and software or require the development of custom technology and software to meet the client's requirements. As an example, the choices for the security component of the CCB 60 can range from the use of the security function of the Oracle database to a totally customized security component. Between these two ends of the spectrum are variations that include specific aspects of the Oracle security component coupled with specific customized components.

The modular code for the CCB 60 is also not limited to one particular computer language. In fact, a CCB 60 can require the interoperation of multiple languages to be compatible with the client's hardware, software, operating system, and other requirements.

The system of the present invention is capable of being installed on computers ranging from a single, stand-alone user installation to a fully Internet enabled, networked system. Stand-alone mode is defined as a single user operating the preferred embodiment on a single computer. As shown in FIG. 7, in this stand-alone embodiment, the CCB 60 and the database 68 are both resident on the user's computer 17, as are the export applications 70 and all other programs that would require a specific file format 80. Any additional required hardware or peripherals 90 are also interfaced with the user's computer 17.

In the stand-alone mode, only one user can operate the system at a time and this user can only work on one plan at a time. There is no interaction with other users or with any other systems or networks. Any security measures written into the system are specific to the individual user's computer 17. The user's computer 17 can be connected to the Internet and information relevant to the planning can be copied from the Internet or selected hyperlinks noted in the plan, but no information is shared via the Internet. An example of the stand-alone mode is a single individual using the system to record the work of a group of planners operating in the same space.

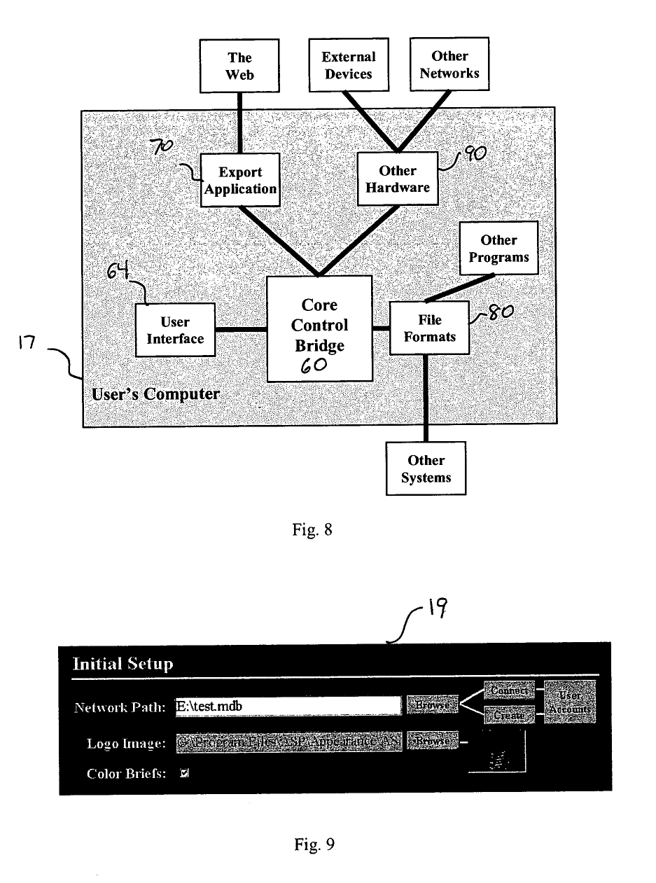

The networking mode is shown in FIG. 8. In the networking mode multiple users operate multiple computers from multiple sites with the ability to collaboratively work on the same plan or work different plans concurrently. A network can be classified as an organizational intranet, the Internet, or a combination of both and has many advantages over a stand-alone installation. When networked, the user can collaborate with multiple users through networking tools such as chat rooms or E-mail, and interact with a wider variety of export applications 70 to include the World Wide Web. File formats 80 are generated in the system to interact with other systems and non-computer hardware and peripherals 90. The user also interacts with other computer networks and external devices such as recording media, or telecommunications equipment.

Another feature of the system in the network mode is the ability to establish security protocols for all users. Examples of these protocols are password protection and user group accounts. These security features control user and group levels of access to various subroutines, menus, and screens. They can also be configured to allow certain individuals edit or release authority for certain aspects of the planning process. FIG. 9 is an example of the initial setup depicting the network pathway and the user account button of the configuration screen 19 that was created using Microsoft Access, although any database program may be used.

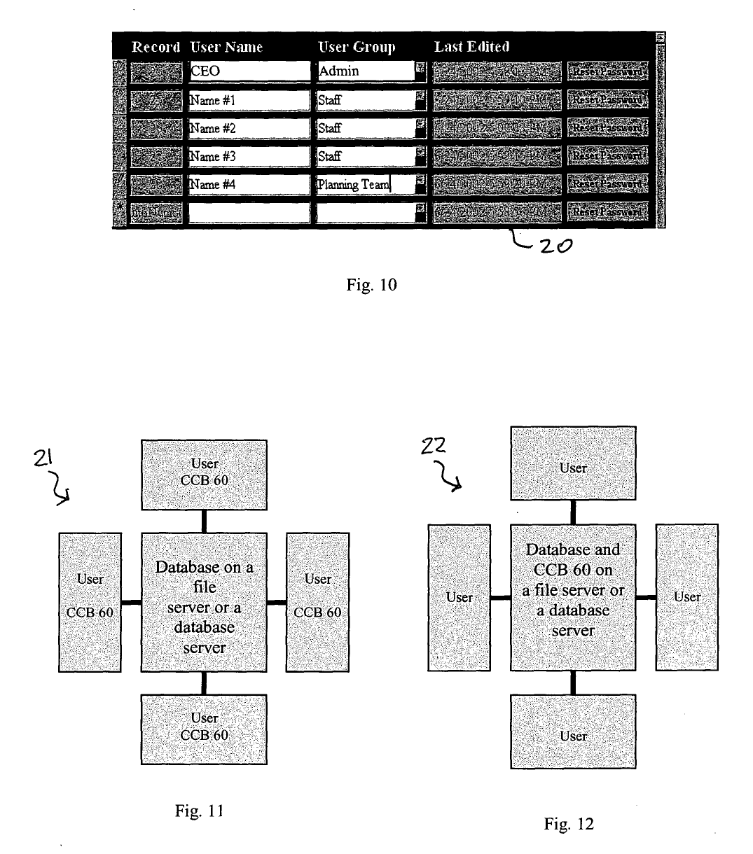

FIG. 10 is an example of a user account page 20 that was created using Microsoft Access, although any database program may be used. This example depicts the User Name column that becomes the login identification and several user groups who have varying privileges and passwords when entering the system.

The invention is capable of being implemented in variety of different network installations depending on the client's requirements. One embodiment may be a network installation 21 as shown in FIG. 11, where each user has a CCB 60 module on his workstation with all of the associated hardware and software. The database 68 is resident either on a file server or a database server and is a shared resource for all users as shown.

An example of this type of network installation is an intranet or Internet network where the database 68 is shared on the host server but the CCB 60 is resident on the individual user's computer. The user would access the database 68 through a file share or Open Data Base Connectivity (ODBC) protocol, or other equivalent protocol. In this example, the users do not have to be working on the same plan nor do they need to be in the same location. They could, in fact, be geographically separated as in a collaborative distance-planning event.

Another type of network installation 22 is shown in FIG. 12 in which the database 68 and CCB 60 are both resident on a file server or database server. This type of installation is effective in an Internet or intranet arrangement where the user is linked to the server by an http, html, or other network-based protocols.

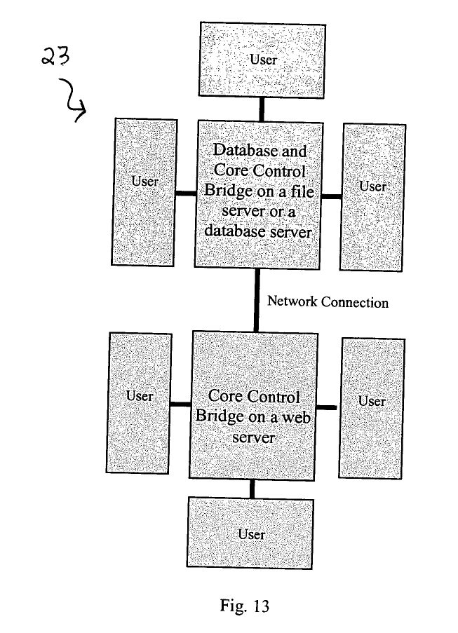

By adjusting the location of the database 68 and the CCB 60 in an intranet, Internet, or combination scenario, a number of potential installation scenarios are possible. FIG. 13 is a variation on the last two installation methods, where the network installation 23 includes two CCB's 60 interacting with a single database 68 loaded on one of the servers.

An example of this type of installation is one where the database 68 is resident on the server of a parent company or organization. The parent company has a CCB 60 for its users to access the database 68. A subsidiary company may then access the parent company's database by means of a network connection. The subsidiary company has the second CCB 60 on its server.

Regardless of the type of installation an organization requires, the invention is capable of operating in all types of networking scenarios. Even when the database 68 is resident on one server and not compatible to a second server, the system is capable of generating a file format to exchange the requisite information as describer later.

Use Interface Overview

The user interface 64 for the system will now be described. The user interface is the mechanism that allows the user to enter information, display information, and navigate through the established program. Using a computer system(s) as the primary means of user interface, current man-machine interface technology consists of a keyboard, a mouse, a light pen, or some form of voice recognition equipment. While the invention was designed to use existing interface equipment, as technology becomes more advanced, the system is adaptable to future interface development.

The computer monitor is the current technology for the display and presentation of information. The presentation formats available to the user are extremely varied, ranging from a simple tab or command button to web browsers and hyperlinks. The invention is capable of using any presentation format desired by the client.

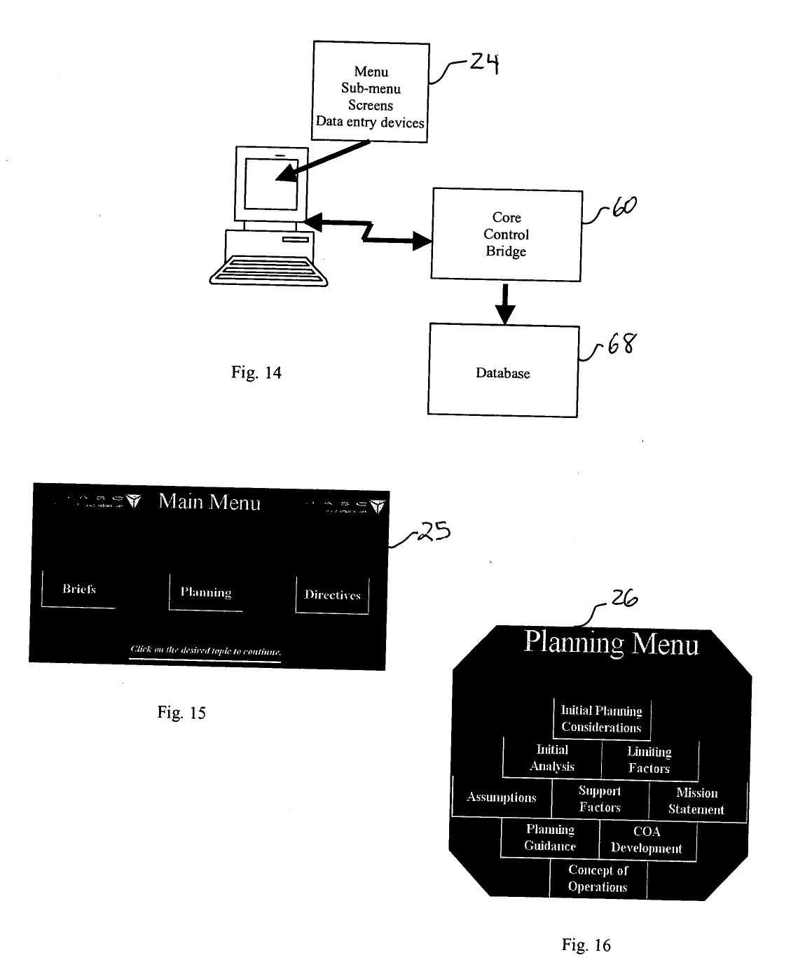

The most common example of a presentation format is the use of a menu driven design 24 similar to the one in FIG. 14. In this example, the user is presented various menus, sub-menus, and individual screens that depict the specifics of the desired planning model.

FIG. 15 is an example of the main menu 25 from a planning model. Again, the menu can be constructed to use a variety of presentation formats. In this example, the user can select a specific planning function (Briefs, Planning, Directives, for example) by using a mouse to click on the desired topic.

Like the formats for menus, sub-menus can also use a variety of presentation styles. In the example of FIG. 15, by pressing the “Planning” button, the user is shown the planning menu and sub-menu buttons 26 depicted in FIG. 16. Exemplary sub-menu functions identified in FIG. 16 include Initial Planning Considerations, Initial Analysis, Limiting Factors, Assumptions, Support Factors, Mission Statement, Planning Guidance, COA Development and Concept of Operations. Of course, these menus and sub-menus may be readily adapted to the organization objectives and focus.

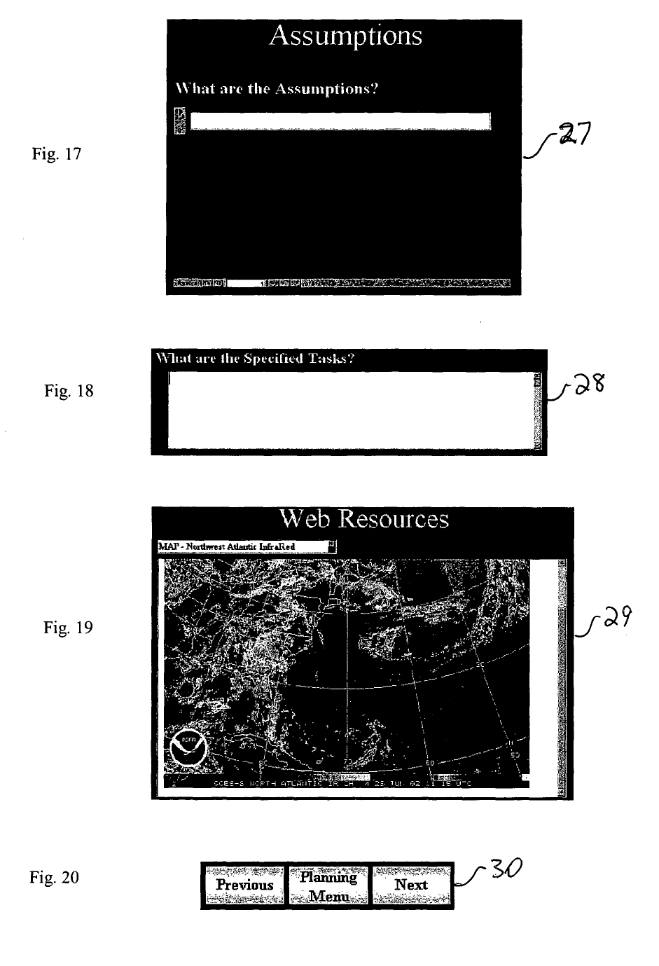

Continuing the example of FIGS. 15 and 16, each button in the sub-menu takes the user to a series of screens where the information for that particular topic (Assumptions for example) is entered as shown in FIG. 17. Information is entered and displayed on the individual screens through the use of various data entry devices. One such data entry device is the sub-form 27 of FIG. 17. A sub-form 27 allows the entry of multiple records for a specific topic. In the example shown in FIG. 17, the user can enter multiple assumptions in the assumptions sub-form 27 and then move between these records to edit, copy, or delete by using the navigation bar on the bottom of the sub-form 27.

Another type of data entry device is the dialog box 28. These data entry devices are designed for entering information in text format into the planning process as shown in FIG. 18. This text can be free form or “bullets” and edited using traditional word processing techniques.

Data entry devices can also import information from other locations to include for example, other databases, other application programs, or the World Wide Web. The invention is capable of importing web information as well as creating a hyperlink to specific web sites for additional information. FIG. 19 is an example of a satellite photograph 29 imported into the planning model from the National Oceanic and Atmospheric Administration web site.

There are data entry devices that allow the creation of charts and graphs. Microsoft Chart, for example, can be used to track the development of a hurricane or other natural disasters. Other data entry devices can provide full graphics, animation or sound. These devices can be used to predict probable landfall or project storm tracks of major hurricanes.

There are another group of devices that use speech-to-text and voice recognition as the primary means of data entry. While not a visual interface, these devices are an interface method for visually impaired persons to navigate the system and enter data into a planning model.

The final characteristic of a menu format is the use of navigation devices to move through the program. Like data entry devices, navigation devices vary in complexity and design from a simple button 30 to a hyperlink (see FIG. 20).

Core Control Bridge Interfaces

When interacting with the user interface 64 in the stand-alone installation mode, the CCB 60 performs two primary functions. First, the code in the CCB 60 processes and distributes information entered by the user to the database 68 or to other applications 70, systems or networks 90. Second, the CCB 60 exercises direction over which elements of the presentation format are displayed, when these elements are displayed, and through which format these elements are displayed.

Using the previous example from the menu driven user interface 24, the CCB 60 takes the information entered by the user on the various planning sub-menus and screens and distributes this information to the database 68. The CCB 60 also displays the information entered in the various menus, sub-menus, and screens as selected by the user.

In the networked installation mode, the CCB 60 has other functions in addition to the ones described in stand-alone installation. As part of the direction function, the CCB 60 maintains selected security features that limit access, require passwords, and allow the user right to view, edit, and control selected features. In the network mode, the CCB 60 performs an update function when multiple users are entering information on the same plan at the same time. Based on defined security procedures, the CCB 60 also arbitrates between multiple users when entering information or editing previous data.

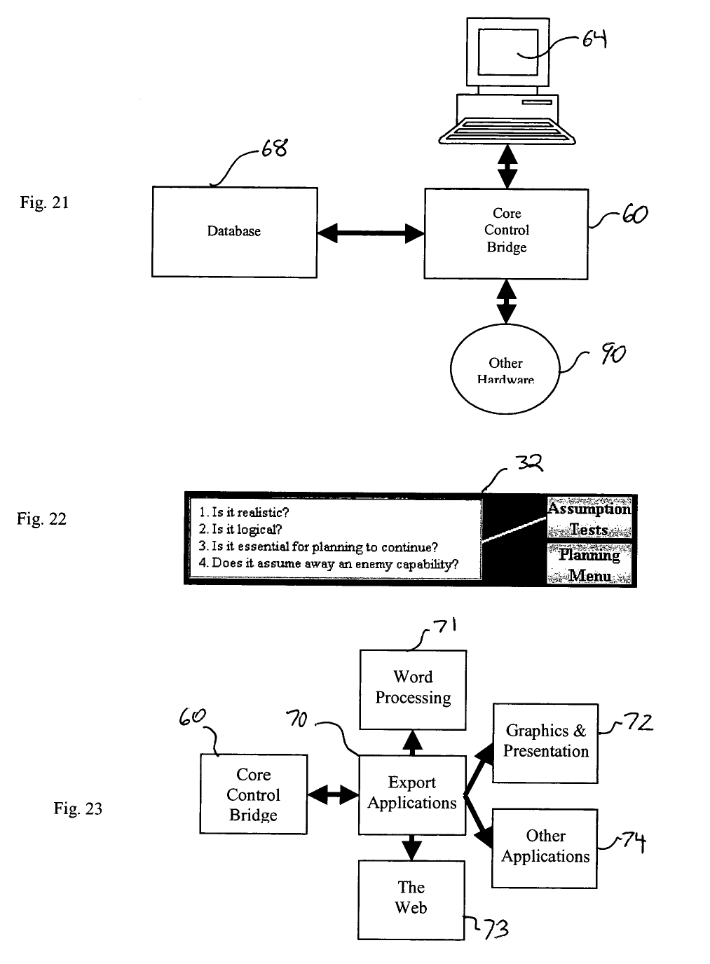

The database 68 and its interaction with the CCB 60 will now be described. As depicted in FIG. 21, the CCB 60, in conjunction with user interfaces 64 or other types of hardware 90, sends and receives information from the database 68. In the process of sending information to the database 68, the CCB 60 can manipulate the data before entering it into the database 68, such as parsing and validating the data fields. The CCB 60 can also manipulate the data coming from the database 68 before sending it to the user interface 64, the file format 80, the export applications 70, or the other hardware 90.

The CCB 60 is also capable of executing queries of the database 68 on behalf of the user through the user interfaces or on behalf of other devices or software. An example of this query capability is an information button 32 shown in FIG. 22, which may be displayed on a screen in one of the planning process sub-menus. When pressed, the CCB 60 queries the database 68 for some previously entered information or, in this case illustrated in FIG. 22, for the tests to be performed to validate an assumption.

The system is not limited to the data base application of a single platform or operating system. The system is capable of using a variety of data base applications in support of the client's requirements.

The export application 70 and its interaction with the CCB 60 will now be described. The system is not limited to one specific export application or family of applications. Referring to FIG. 23, the CCB 60 of the system is capable of interacting with a variety of export applications and application families including but not limited to word processing 71, graphics and presentation 72, the World Wide Web 73, and other applications 74.

The CCB 60 performs three primary functions when interacting with export applications. First, the CCB 60 controls the export application 70 for purposes of automation of the external application. Second, the CCB 60 manipulates the export application 70 by parsing/validating data to and from the database 68 and receiving feedback from the export application 70. Finally, the CCB 60 controls the structure of the export application 70 and provides a template of all required formats.

As an example of this interaction, the CCB 60 can take information from the database 68 to generate a presentation in Microsoft PowerPoint (for example, presentation application 72). The CCB 60 exercises overall control over the export application, PowerPoint, and defines the template for this presentation. As data is moved from the database 68 to the presentation application 72, the CCB 60 receives feedback from PowerPoint on select aspects of the program. For example, the CCB 60 can receive feedback from PowerPoint that the data to be presented is too large to fit on the formatted template. The CCB 60 then tells PowerPoint to add another page to the template. Once the presentation has been created with Microsoft PowerPoint, the CCB 60 can generate a document or directive using the same information but in a Microsoft Word formatted template (for example, word processing application 71).

The system can also work with non-commercial software, proprietary software, or software that is not widely distributed. In order to operate non-compatible software programs or interoperate with dissimilar computer systems, the CCB 60 utilizes the requisite file formats 80 to be compatible with these programs and systems. The invention is not limited to a specific file format or exportable format. The system is capable of producing a variety of conventional file formats to meet the client's requirements. The system is expandable to accommodate future file formats and special file formats by writing specialized file export code.

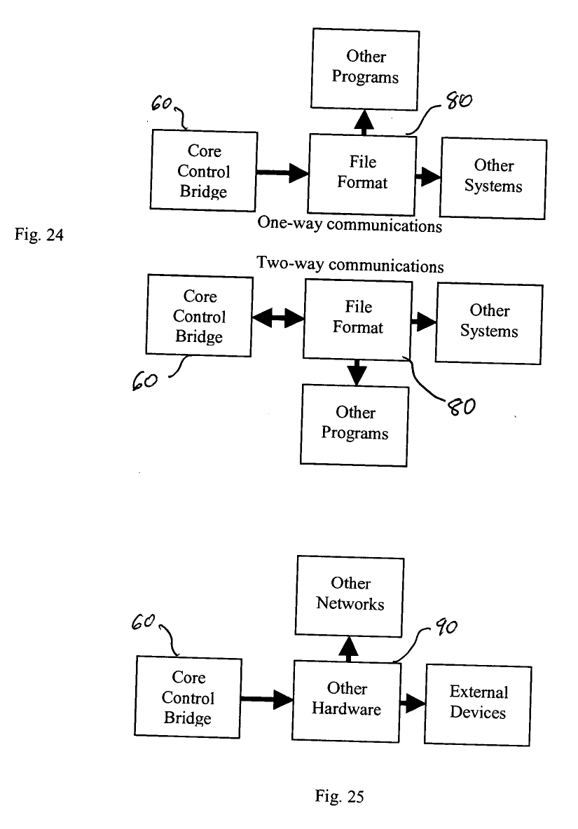

As depicted in FIG. 24, the CCB 60 operates in either the one-way or two-way communications mode. In the one-way mode, the CCB 60 creates a file format 80 to interact with a specific software application or a specific hardware system. As an example, if a client ran a Microsoft operating system and was required to use Star Office as their word processing application, the CCB 60 would generate the requisite control files to interact with the non-compatible word processing format of Star Office.

In two-way communications, the non-compatible hardware or software also interacts with the CCB 60 by bringing in configuration files or read back files from the other application or system. For example, a client running a CCB 60 with a practical extraction and reporting language (PERL) script on a Unix operating system can generate control file formats 80 to interact with telecommunications systems such as paging devices, voice recognition devices, or initial voice response (IVR) systems. These devices can communicate back their configuration files or a read back file to the CCB 60.

The system is capable of interfacing with a variety of computer hardware and peripherals, other computer networks, and other external devices (collectively, reference numeral 90 as shown in FIG. 25). External devices may include but are not limited to a facsimile machine, a printer, a scanner, speakers or other audio output devices, and audio input devices such as a microphone. For an example of interaction with other networks, the system may be linked by a serial port connection to a modem for purposes of dialing up another network service such as a bulletin board.

As depicted in FIG. 25, the CCB 60 sends information to and receives information from these external devices or other networks 90. The CCB 60 can send or receive this information from other hardware as either parsed (separated into some workable format) or unparsed (raw data) data.

Database Overview

Regardless of the programming language being used, all databases fundamentally operate in the same manner, that is, they store data. As used in the present invention, the database is a collection or repository of information relevant to planning. When used in conjunction with the routines defined by the programming code of the CCB 60, the database provides the information to be used, stored, formatted, or otherwise manipulated to achieve the desired outcomes.

Within the contents of most databases are information organization tools that allow the programmer to classify or sort information in the database. These tools are the table, the record, and the field.

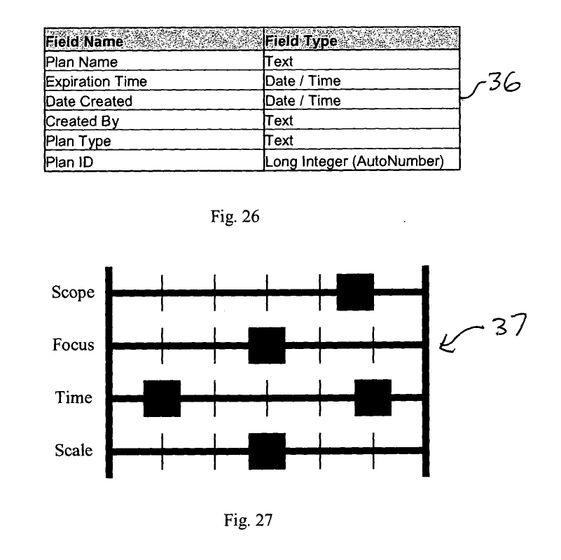

A table is defined as a collection of information that is organized by records and fields. FIG. 26 is an example of a Plans Table 36 that was created in Microsoft Access. Creating the tables in a database of any type, and providing the table name of any type, is a function of the programmer.

A record is a single grouping of information within a table. In FIG. 26, a single plan record contains all of the information listed in the left column. The user generally inputs record information, although certain records can be generated programmatically. Examples of programmatic records are Plan ID or Record ID.

A field is a component or section of a record and establishes how information is to be classified or sorted. As with tables, the programmer determines the fields to be used, assigns field names, and indicates the type of field. In the table 36 in FIG. 26, each row of the table constitutes a field.

An example of how the database 68 and the CCB 60 interact can be demonstrated by using the Plans Table 36 in FIG. 26. The Plans Table 36 contains a listing of all of the plans resident in the database 68 of the invention. When the user creates a plan in the system, the coded routines of the CCB 60 examine the database 68 to determine if the plan name is valid. If the plan name is accepted, the CCB 60 then directs the creation of the plan in the Plans Table 36 of the database 68 and auto-fills selected fields of the new plan record. In this example, the Expiration Time field is auto-filled based on input from the user in the duration block of the configure screen. The CCB 60 manipulates the user entry and auto-fills the Expiration Time field using a date/time field type. The remaining fields of the new plan record are filled by the user from specific screen inputs in the program or by prompting by the CCB 60.

The CCB 60 accesses and manipulates the information in the database 68 using four different methods. In the first, the CCB 60 accesses the table directly. For example, creating a new plan on the configure screen causes the CCB 60 to directly access the Plans Table 36 and add a new record for the newly created plan.

The second method uses Data Access Objects (DAO) to access the information in the database. A DAO is a specific set of programming code resident in the CCB 60 that can access a table directly or use a sequential query language (SQL) statement to return a specific record or set of records. An SQL statement can be fixed or dynamic depending on the nature of the query. A fixed SQL statement queries the database using the same question and expects a response in a specific format. For example, when a user enters a log-in identification, the CCB 60 uses a fixed SQL statement to query the database 68 for the specific password associated with the log in ID. A dynamic SQL statement is used to query the database 68 when selected fields of the table have been manipulated or modified by the user. An example of a dynamic SQL statement occurs when the user adjusts, modifies, or prioritizes the order of a series of records based on a specific variable or set of criteria.

The third method of information access is the query. Each screen and sub-form in the planning program has a query associated with it. The query limits the results returned to the screen by filtering the information through a set of specific parameters. For example, when multiple plans are resident in a database 68, the query for a specific screen or sub-form would return only information relevant to the plan being worked.

The last method of information manipulation is the use of control tables. These tables control the way information is organized, manipulated, and disseminated through the exclusive use of Data Access Objects. An example of a control table is the Word Document Generation Table that is required if the word processing export application is Microsoft Word. The routine of the CCB 60 accesses the Word Document Generation Table and uses the results to populate and format the required Word document.

Another feature of the invention is an updating utility function that allows the user to modify the system as updates or changes become available, modify the system to interoperate with new software, hardware, operating systems and other computer peripherals, or import new non-computer features required for the planning process. Updates are provided to the user by distributing software media, or automatically via the World Wide Web or other electronic transmission means.

The user may receive or access the system in one of three application delivery methods. In the decentralized method, the system is distributed directly to the user in the form of software. In the centralized method, the system is maintained by a third party application servicer and provided to the user as a World Wide Web based service. The third method is a combination of centralized and decentralized service where selected parts of the system are distributed to the user with the third party application servicer maintaining other sections and providing them via the World Wide Web.

Exemplary Planning Model/Event

The primary modules, their functions and characteristics, and their interactions have been described above. A detailed description and of an exemplary planning event will now be described to further highlight the features of the invention. Note that this example is for illustration purposes, and that certain assumptions are made and certain configurations are identified, but the invention is not limited to those specific assumptions and configurations identified in this example.

Also, while this model/event is directed to disaster preparedness, the invention can accommodate a wide variety of planning models that require a structured approach to planning in a collaborative manner.

As a brief background on the planning scenario, Middletown is a city of about 500,000 people located on the eastern seaboard of the United States. The city has experienced a tremendous population growth over the past two decades and projections indicate this growth pattern will continue for at least another decade before leveling off.

Four years ago Middletown was on the periphery of a Category 4 hurricane that severely flooded many of the cities to the immediate south. Most of the areas were not prepared to deal with such a catastrophic event. Recognizing the requirement to provide for disaster preparedness and disaster relief, Middletown recently embarked on an effort to conduct pre-catastrophe disaster planning and oversee disaster relief efforts. Middletown will employ the present invention to facilitate the disaster planning process.

First, an initial formative evaluation is conducted to determine the specific requirements and assess the current capabilities of Middletown's disaster planning efforts. In this example, a formative evaluation is defined as those activities undertaken during the design phase of program development that guide the overall design process. These activities may include but are not limited to personnel interviews, defining of goals and objectives, policy analysis, and pre-testing/pilot testing of software designs.

Based on this formative evaluation and discussions concerning the planning matrix, Middletown's planning requirements are depicted in the planning matrix 37 shown in FIG. 27. Since these planning efforts are directed at disaster preparedness and disaster relief, the “Scope” of the planning effort is viewed as extraordinary or spectacular in nature (see FIG. 1). While some of the planning efforts may focus on “Short Term” or operational activities, other activities are seen as strategic or “Long Term” in character (see FIG. 2). Similarly, disaster preparedness is viewed as more “Deliberate” or non-reactive in nature while the time between start of a disaster relief effort and the expected execution of the plan is more “Time Sensitive” (see FIG. 3). Finally, Middletown's planning efforts are expected to cross “Multiple” departments within the city government (see FIG. 4).

The city of Middletown has defined a disaster planning team from several organizations and agencies in city government. The system and method of the present invention must be networked to all members of the planning team on the city intranet. The principal method of user interface will be by computer and the presentation format requires a menu driven format 24 (see FIG. 21) with the ability to download information from various sources on the Internet.

The database 68 for the invention will be installed on the database server of the Middletown intranet and will become a shared resource for all planners. Members of the Disaster Planning Team will each have a CCB 60 installed on their individual workstations with all requisite hardware and software (see system 21 in FIG. 11 for example).

The principal software used by the Middletown city government is Microsoft Office. The database 68 for the invention will be written in Microsoft Access. Since all city services and agencies use the city intranet, there is no requirement to link with other networks.

The system must be capable of using information derived from the planning process to create briefs for various members of the city government and the media. The principal presentation software 72 (see FIG. 23) is Microsoft PowerPoint. The system must also be able to use planning information to create various directives for subordinate agencies and organizations using Microsoft Word format 71 (see FIG. 23). There is also a requirement to provide disaster preparedness guidelines taken from the planning process in .html format to upload to the city's web page 73 (see FIG. 23).

In the example being presented, the system was created using a Microsoft Access based programming language. The code routines resident in the CCB 60 manage every high-level aspect of the system. For purposes of clarity, the system includes the CCB 60, the program, and the application. The term program is used to describe those parts of the system that are seen by the user. The application is the requisite code and functionality that permit the program to be seen. In this example, the application has been written in Microsoft Access, and one of ordinary skill in the art would understand the following procedures may be adapted to run on other types of database software.

The CCB 60 is embedded into the system and is also written in Microsoft Access. In a broad sense, the program being seen by the user is run by the application but controlled by the CCB 60. In this example, for all discussions involving the system in the stand-alone mode, both the CCB 60 and the database 68 are resident on the user's computer. In those discussions involving a network environment, only the CCB 60 is resident on the user's computer.

The initial or splash screens are defined as the title, cover page, or other acknowledgements pages that define the overall program and its authors. As the application is loaded and the title screen or form is opened, the CCB 60 directs the running of the CheckNetwork routine. This routine determines if a plans table exists and if the table is accessible. The plans table is a list of plans resident in the database 68 and the plan identification assigned to each by the CCB 60. In a network environment, if the network or file share is not available or the plans table is not accessible, the CheckNetwork routine sends a prompt to the user and asks if he wishes to revert the application to the stand-alone mode. If the plans table is inaccessible and the user opts not to revert to the stand-alone mode, a message is displayed prompting the user to ensure network accessibility.

If the invention is operating in the stand-alone mode, or if in the network mode the user chooses to revert to the stand-alone mode, the CCB 60 executes the DataTableConfig routine with the “(StandAlone)” parameter. The settings table entry for data location in the database 68 is also set to “(Stand Alone Mode)”.

In a network setting, once the CCB 60 acknowledges that the plans table is accessible, the CheckNetwork routine returns code execution to the application title form, maximizes the screen, and, if the system contains the countdown clock as an optional feature, opens the timer form. The timer form is used only if the clock feature is present and is the background form to reset the clock.

The code in the CCB 60 then determines the directory location of the database 68 and what file name is being used for the overall system application. This information is stored in the settings table. If the system includes a logo control feature, the CCB 60 also checks if the logo image has been changed and alters the logo file name and pathway accordingly. Finally, the CCB 60 checks the current working directory of the computer and if required, changes to the directory where the database 68 resides.

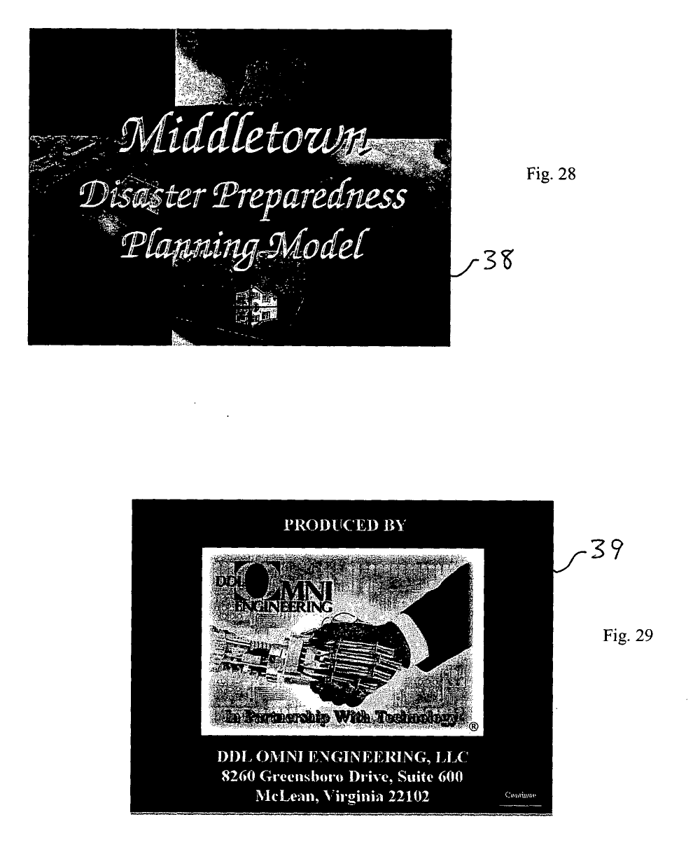

Although these actions are transparent to the user, the title screen 38 is now visible on the computer screen as shown in FIG. 28. The title screen 38 may have a navigation button to advance or rely on a timer function to automatically launch the cover screen after a specified time lapse. The user can also click on the title screen 38 to launch the cover screen immediately and the CCB 60 will direct the change of screens.

In FIG. 29, the cover screen. 39 and other acknowledgement screens will have some form of navigation device. On the final title form screen, the CCB 60 checks to determine if the database 68 is to be run in network mode. If so, the Login screen will appear. If not, the Main Menu screen opens.

After clicking through the title 38 and cover/acknowledgement screens 39, the user is taken to the login form when the system is operating in the network mode. The CCB 60 interacts with the application to perform basic security functions. The first security function is to execute the Activity routine. The CCB 60 uses this routine to check for network connectivity to data tables. If the data tables are accessible, the Activity routine also checks to see if, during the last login, the user had any entries in the activity log that were not complete. If such activities are noted, the CCB 60 directs these entries to be marked complete.

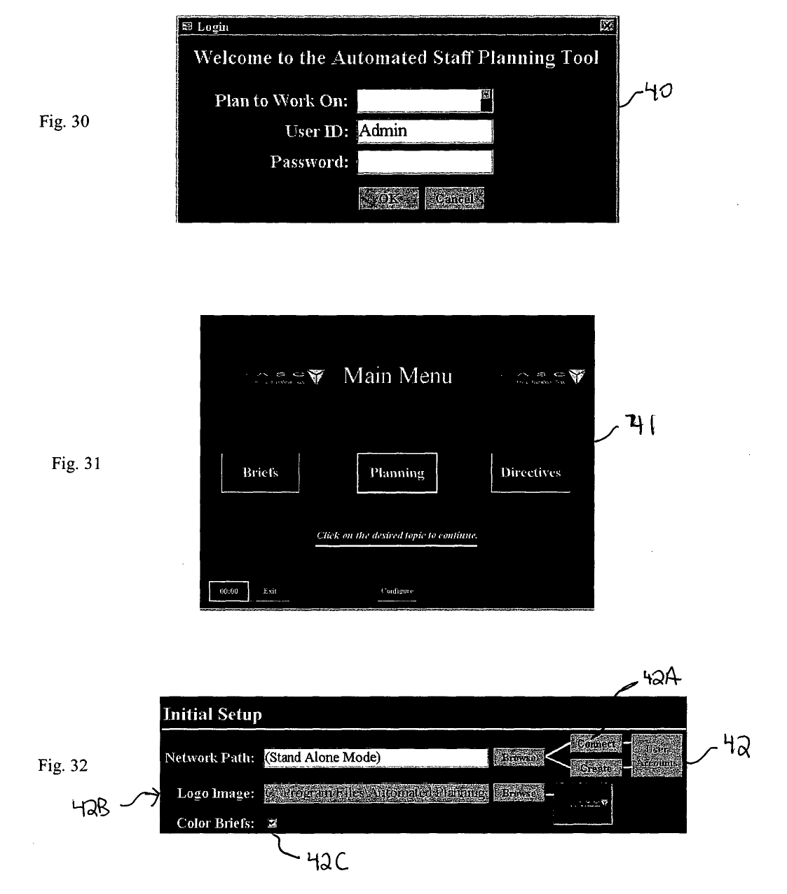

As shown in FIG. 30, there are three text boxes on the login screen 40: Plan to Work On, User ID, and Password. The user can use the drop down menu or type the name of the desired plan into the Plan to Work On box. Provided the User ID and Password are entered correctly and no plan is selected, the CCB 60 security function directs the user to the main menu to enter the configuration screen and create a plan. Any attempt to enter another menu off the main menu results in an error message.

The next security function performed by the CCB 60 is to validate the User ID and the Password. If the Password is correct but the User ID is invalid, an error message is sent from the CCB 60 to request the correct ID or seek assistance. If the User ID is in the users table but the Password is entered incorrectly, an error message is displayed to inform the user that the password is incorrect and returns the user to the login screen. If both User ID and Password are correct, the CCB 60 updates the current user information in the Settings—Active Plan table. The Activity routine is now complete, a new entry is made in the activity log for the validated user, the login screen closes, and the main menu appears.

In this example, the client opted for a basic network security function of matching user identifications against passwords. Depending on the level of security required, the invention can incorporate other security measures including but not limited to voice recognition, security swipe cards, retina scans or other bioinformatics devices.

Once the network security functions have been completed or the user is operating in the stand-alone mode, the next screen viewed is the main menu. As depicted in FIG. 31, the main menu 41 in this example allows the user to select from three menus, Briefs, Planning, and Directives, enter the Configure screen, or exit the system.

In the lower left corner of FIG. 31 is an example of the clock option. In time sensitive planning situations, the user can set the clock function to the desired time to conduct the planning. The CCB 60 monitors the remaining time by using the timer form that was opened earlier. This is accomplished through the use of a control called Time. When the user creates a new plan, the time set on the configure screen activates the Time control. If the user selects an existing plan, the expiration time remaining for that plan is sent from the Time control.

The configure button transports the user to the configure screen. The CCB 60 does not allow the Briefs, Planning, or Directives menus to be accessed unless a plan has been selected. A message box prompts the user to select an existing plan or create a new plan using the configure screen.

The configure screen displays options that can be manipulated by the user and displays controls to create, copy, delete, and select plans or perform other pre-event set up tasks. In the network mode, the CCB 60 checks a user's privileges, and can limit certain controls based on the user's group assignment. In the stand-alone mode, the CCB 60 grants the user full control of all aspects of the system.

As shown in FIG. 32, the top portion of this configure screen 42 is dedicated to the initial setup of the system in either the stand-alone or network mode. In the initial installation of this application, the CCB 60 sets the default to stand-alone mode. Once the system has been installed, the user can set the application to the network mode by typing or browsing to the shared Access database file location.

To direct the CCB 60 to construct a network, the user must first create an external shared database file. The file name and pathway is entered in the Network Path dialog box and the Create button is pressed. The CCB 60 begins the operation by checking to ensure that the path ends in .mdb, the file format unique to Microsoft Access. The CCB 60 also checks to see if the specified database already exists and displays a message box notifying the user if it does. For a new database file, the DataTableConfig routine of the CCB 60 is executed using the path and file name and a Build parameter. The DataTableConfig routine creates the password protected and encrypted Access database file (.mdb) in the specified location and populates it with backup copies of the shared data table structures for the application. The CCB 60 DataTableConfig routine then copies information from the Users, User Groups, and Privileges tables into the new, shared database file and the Settings table is updated to reflect the network path of the shared database file. When the network has been created, the configure screen closes, and the login screen opens.

Once the CCB 60 has successfully created the external shared database file, other users can join the network through the use of the Connect button 42A shown in FIG. 32. The Connect button 42A allows a user to connect to an existing shared database file created by another user. The user defines the desired network path and presses the Connect button 42A. The CCB 60 checks that the file specified ends in with the appropriate file format (.mdb) and then attempts to connect to the specified database file. If the file does not exist, a message is displayed indicating so. If the database file exists, the DataTableConfig routine is executed with the appropriate network path and filename parameters.

The DataTableConfig routine prompts the user regarding pending connection to the specified database file and requests an entry to continue or cancel. If the user continues, the CCB 60 executes the CopyAndLinkTables routine with the path and file name, as well as the Link parameter. The CopyAndLinkTables routine uses the Networked Tables table entries to link to the appropriate tables in the shared database file. The Networked Tables table contains a list of all tables containing information to be shared in the planning process. The CCB 60 then updates the Settings table to reflect the network path of the shared database file. The CCB 60 also exercises additional security functions through the CopyAndLinkTables routine by using a predetermined master password to access the shared database file. Once the user has been successfully connected to the shared database file, the CCB 60 closes the configure screen and opens the login screen.

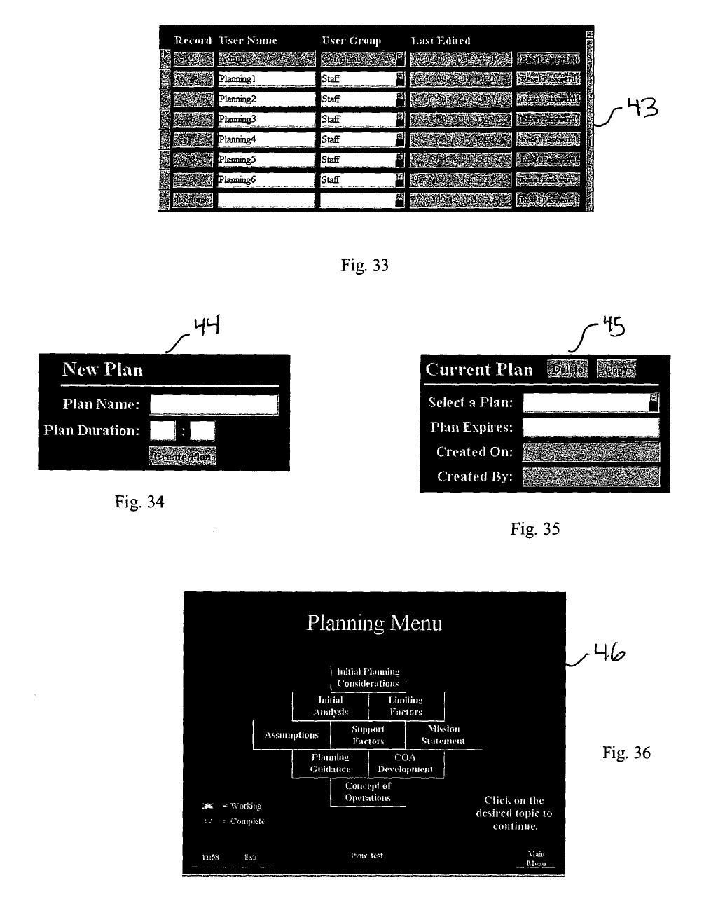

Once a user has created or connected to a database file, and logs-in from the login screen, the user accounts button becomes accessible if the user's identification belongs to the requisite user group. The CCB 60 enforces security and provides basic facilities for administration of all users through the User Accounts screen. The User Accounts screen 43 is a list of existing user accounts, a display of their specific user group, and a reset password button as shown in FIG. 33.

The user can move from the network mode to the stand-alone mode by reversing the process. Entering STANDALONE in the Network Path box and pressing connect or create will display a message confirming the user's intention to revert to the stand-alone mode. The CCB 60 executes the DataTableConfig routine with the STANDALONE parameter. The DataTableConfig routine then copies all of the backup copies of the shared data table structures for the application and severs the shared database file connection. The Settings table is then updated to reflect the stand-alone mode.

As shown on the bottom section of the initial setup section of FIG. 32, additional features can be constructed to support the user in his planning effort. In this case, the user has the option to alter the logo design to something other than the default image. The user can click Browse and choose a new logo image graphic file 42B. The CCB 60 saves the path to this file name and stores it in the Settings table. The image is then inserted into the Settings—Images table and displayed on various forms throughout the application.

Another feature depicted on FIG. 32 is the ability to create briefs in color or black and white 42C. Here, the Middletown user had a requirement to send briefs via E-mail to various departments of the organization. The bandwidth requirements for a black and white presentation are significantly reduced from those of a color brief.

The New Plan 44 section of the Configure screen allows a user to create a new plan with a unique name and to specify the plan duration time (see FIG. 34). The plan duration is the box that directs the CCB 60 to set the clock feature. Once a new plan name and duration have been entered and the Create Plan button pressed, the CCB 60 Create Plan routine checks validity and uniqueness of the plan name and validity of the plan duration. The CCB 60 then creates a plan entry in the Plans Table 36 (see FIG. 26), including information specifying who created the plan, when the plan was created, and the expiration time. The CCB 60 Create Plan routine then opens the BuildNewPlanData routine and generates a plan number for the auto number field of the Plans Table 36 as a parameter. This number is referred to as the Plan ID that is used throughout the application to create and filter information for a specific plan.

Once the plan identification has been created, the CCB 60 BuildNewPlanData routine opens the New Plan Tables table and uses the entries in this table to add a singular record with the current Plan ID. The Planning Menu Completion table is updated with a list of submenu identifiers to the planning menu matched against the current Plan ID. The CCB 60 then displays a message to indicate that plan creation is complete.

Now the user can select the newly created plan or other existing plan 45 from the list on the current plan side of the working setup (see FIG. 35). Once a plan is selected, the CCB 60 uses the Plan ID to find the correct plan in the Plans table. The plan details are then copied into the Settings—Active Plan table. The Activity routine is then executed to indicate to the Activity Log table that the user desires to work this specific plan.

Several other features can be built into the configure screen. In this example, the user requires a copy button to copy the selected plan. To copy a plan, the CCB 60 Copy routine displays an entry box for the new plan's name, validates the entered plan name for uniqueness, and executes the CopyPlan routine with a new auto number generated Plan ID and the new Plan Name. The Plan ID of the selected plan is used to filter information from the tables listed in the Networked Tables table and copies data from all tables associated with the selected plan. Each of the fields of all tables listed in the Network Tables table are copied, except for the Plan ID field as well as the Users, User Groups, Privileges, Plans, and Activity Log tables. The CCB 60 populates the Plan ID for each table listed in Network Tables with the new Plan ID and enters the new plan on the select plan list.

Another optional feature required by the user is the delete button. The delete button allows the user to delete a plan and all related entries based on the Plan ID and Plan Name. The CCB 60 Delete routine uses the Networked Tables table to specify tables for a custom delete query to remove all entries and the selected Plan ID. The only exceptions are the Users table, the User Groups table, and the Privileges table. The Delete routine also removes the entries in the Settings—Active Plan table so the deleted plan does not appear on the select plan list.

After selecting a plan, the user returns to the main menu and begins the planning effort by selecting the planning button. Once in the planning menu, the CCB 60 controls the screens and data entry devices that are run by the application and viewed by the user. The planning menu 46 as shown in FIG. 36 consists of a series of topics or areas related to the planning model used by the client. The individual buttons on this screen are the sub-menus and transport the user to the individual screens to be completed as part of the overall planning effort. These individual buttons may be customized for each client.

An optional feature of the system is the color-coded sub-menu status function. When the planning menu begins, the CCB 60 checks the status of each sub-menu and changes the color of the buttons accordingly. The sub-menu status may, for example, be one of three completion states (colors), unedited (red), working on (yellow), and complete (green). The CCB 60 uses the GetCompletion and SetCompletion routines to control the status of the sub-menus. Both of these routines use the values in the Planning Menu Completion table to evaluate Unedited, Working On, or Complete. The GetCompletion routine provides the current state of a sub-menu while the SetCompletion routine establishes the state of completion of the sub-menu.

When the user opens a specific sub-menu, the CCB 60 prompts the application to display a series of individual screens related to that sub-menu as well as the requisite navigation buttons to move through the screens. The individual screens use Access specific forms to enter plan specific information. These forms are connected to tables and queries that filter information based on the Plan ID identified in the Settings—Active Plan table. These screen specific forms also contain routines to validate information and may generate complex data structures for specific sub-menus and screens.

The CCB 60 also directs the planning menu timer function to refresh screens at predetermined intervals. In a network environment where multiple users may be operating on the same plan or even on the same screen within a single sub-menu, the overall status will be current within this pre-established time.

To further understand the interactions of the CCB 60 and the specific screens of the individual sub-menus of the planning menu, one will be examined in detail. In this example, the mission statement sub-menu provides the requisite detail on CCB 60 interaction. The information produced in this particular sub-menu is also carried over to the briefing menu and the directives menu.

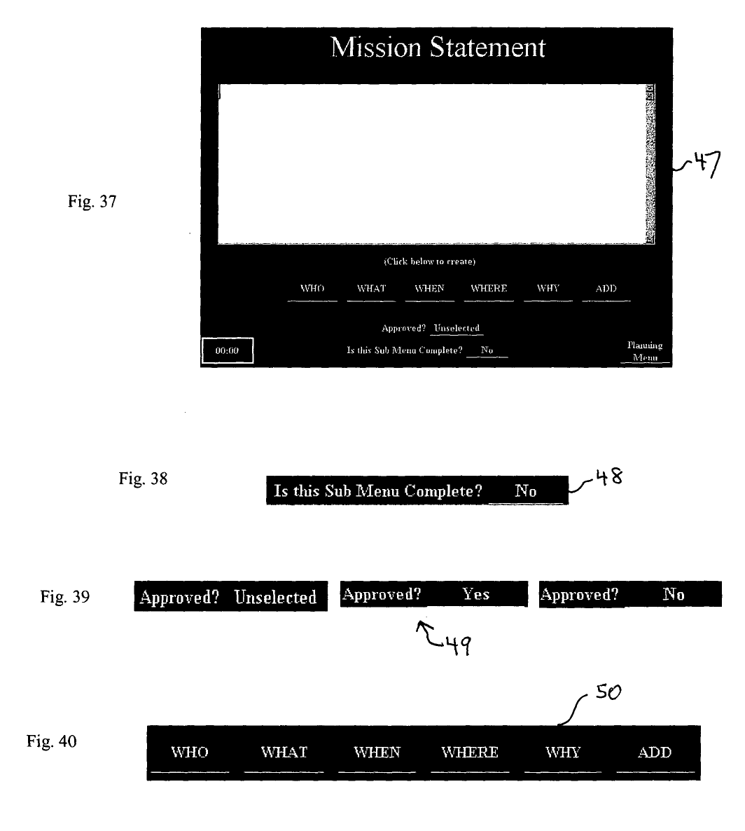

The mission statement sub-menu 47 consists of only one screen containing one large text box and nine navigation or information buttons as shown in FIG. 37. The text box is the data entry device used to enter information about the mission statement into the database. The CCB 60 populates this screen using a query called Planning—Mission Statement Data.

Unlike other screens and sub-menus in the application, this specific query only allows one mission statement record to be stored in the database 68. The specific table containing the mission statement information can reside locally in the current application in the stand-alone mode or within a shared network database file. Regardless of location, the name used for this table is identical. The initial record for this sub-menu was created in the CreatePlan routine when the plan was entered in the NewPlanTable table. The CCB 60 defines the location in the database 68 by using the current Plan ID specified in the Settings—Active Plan table and edits or retrieves the statement based on that identification number. Since there will be only one mission statement, there are no other Microsoft Access navigation buttons associated with this screen.

In a network environment, certain sub-menus can be locked so when a user is working in this sub-menu, no other users are allowed entry. This prevents concurrent editing. The CCB 60 uses two routines to control the locking system, LockState and GetLockUser. The LockState routine accepts a submenu identifier as a parameter and returns a value of true if a submenu is locked. The GetLockUser routine identifies the individual locking the sub-menu through the User ID as the parameter and notifies other potential users exactly who is working in the sub-menu.

When the mission statement sub-menu is opened, the CCB 60 executes the SetAccessLevel routine to control a user's abilities to edit this screen. The properties that SetAccessLevel modifies are the Allow Edits, Allow Deletions, Allow Additions, and Data Entry properties. In the stand-alone mode, the user is authorized access to all screens and functions. In the network mode however, it is the user group that determines access privileges. The CCB 60 queries the Privileges table to identify a user's access based on which privileges have been assigned to the user and what privileges are required for this specific screen.

All submenu screens in this example contain a common code routine to specify First, Middle, Last, or Only for the navigation buttons by using a hidden text box DefaultValue property. This code allows the CCB 60 to control how navigation buttons will appear at the bottom of the form. For example, as part of the completeness option (colorization) for the sub-menus on the planning menu, there is a screen completion button 48 on the last screen of each sub-menu as shown in FIG. 38. If the CCB 60 identifies the individual screen as Last or Only, then the completion button will appear at the bottom of the form using the SetCompletion routine to perform this operation.

An optional feature of the mission statement screen is the approval button 49 as shown in FIG. 39. In the network mode, once the mission statement has been drafted and agreed to, a user from a specified user group uses the approval button to lock in the statement and prevent unauthorized users from altering the desired mission statement. The CCB 60 controls this process through the value of the Approval field as presented by the Planning—Mission Statement Data query. Once the approval button 49 has been activated, only designated user groups can edit the mission statement text box. Users from other user groups are denied editing privilege.

Another optional feature of the invention is for information to be entered in a data entry device and the application to generate a statement, table, or graph. One of these features is part of the mission statement screen as shown in FIG. 40. The program assists the user in creating a mission statement in the proper syntax using the five buttons labeled Who, What, When, Where, and Why 50. The user selects the desired button and inputs the desired data. The CCB 60 directs the establishment of five identical text boxes that are used to temporarily store each piece of data while other entries are being completed. Activating one of these buttons hides all but the designated text box. Once all five have been completed, the user presses the Add button to create a computer generated mission statement in the text box.

In this example, once the user has completed the planning process, the system has the ability to generate a brief. The presentation software used to generate the brief is Microsoft PowerPoint in this example. The CCB 60 uses the information produced in the planning menu and stored in the database 68 to populate the brief.

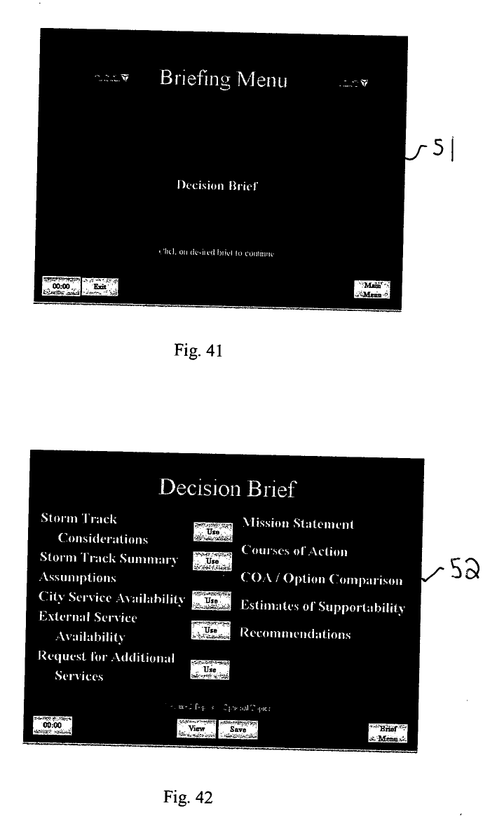

The brief menu 51 contains the requisite navigation techniques to open the different briefs and navigate to other desired locations in the menu. In this example, there is an option to select one brief, a button to return to the main menu, and a button to exit the system as shown in FIG. 41.

Briefs can be configured with a variety of options depending upon user requirements. Once the individual brief has been opened, the user can configure the brief from the options available. Each brief screen contains a list of required and optional topics for each brief. In the decision brief screen 52 shown in FIG. 42, all of the topics relate to storm disaster preparations and responses, and the user can add optional topics to the existing topics. Of course, the list of topics may be customized for each planning situation or planning model. The user then selects the view button to view the brief, or the save button to save the brief.

All briefs in this example are generated using the required automation to control the Microsoft PowerPoint application. When the user clicks the view or save button, the CCB 60 executes the GenerateDecisionBrief routine with the appropriate Save or View parameter. The CCB 60 then creates a new presentation and applies the master slide template to the new presentation. The FormatMasterSlide routine is executed as part of the master slide template to insert the appropriate logo images on each page of the presentation. While the brief is building, the CCB 60 displays a Please Wait form and updates the status of the presentation by showing the title of the presentation slide being built. For each slide being created, the CCB 60 uses the AddSlide routine to add new slides to a brief. If data for a slide is unavailable or the required planning screen has not been completed, the CCB 60 does not generate a PowerPoint slide.

The CCB 60 uses the ParsePP routine to determine how PowerPoint will parse the data to be added to a slide. These values are passed to the FormatSlide routine to rebuild the slides as necessary in the proper format. This routine causes PowerPoint to generate additional slides when the amount of data exceeds the predetermined parameters for each slide. If an additional slide is required, the CCB 60 executes the AddContLabel routine to add a Cont. label to the appropriate slide in the presentation.

Back in the planning menu, the CCB 60 inserted the data from the mission statement screen into the database 68. When building the presentation, the CCB 60 uses the Planning—Mission Statement Data query to locate the appropriate mission statement data and inserts this value into a text control on the correct PowerPoint slide. Both the slide name and slide title are specific to this slide. The CCB 60 uses the slide name in the AddSlide routine to create the slide. The slide title is then inserted into a text control on the slide. If the mission statement data returned by the Planning—Mission Statement Data query is null or has no data associated, the mission statement slide in PowerPoint will not be created.

The CCB 60 generates certain slides outside of the main GenerateDecisionBrief routine due to their complexity. These slides typically contain tables of images and text, are not parsed with the ParsePP routine, or use the FormatSlide routine. The code in the CCB 60 contains all the necessary routines to transfer the data from the database 68 to these customized slides and all the necessary formatting and parsing code to generate each PowerPoint slide.

The final process in the GenerateDecisionBrief routine is to save or view the presentation. If save was selected, the CCB 60 opens an entry box with a default file name to save the presentation. If view was selected, the CCB 60 opens the PowerPoint application and sets PowerPoint as the active program in windows.

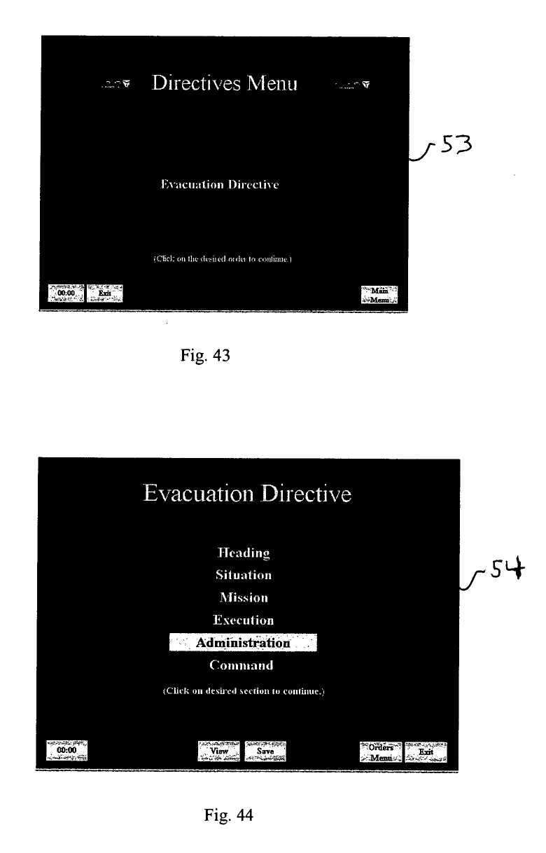

In the final section of this example, the user has opted to include a directives menu to transfer data produced in the planning menu to some form of guidelines or instructions. The directives menu 53 contains a list of required directives as shown in FIG. 43. In this example, there is one directive called the evacuation directive that will be created using Microsoft Word as the word processing software. Also included on the directives menu are the necessary navigation tools to move through the menu.

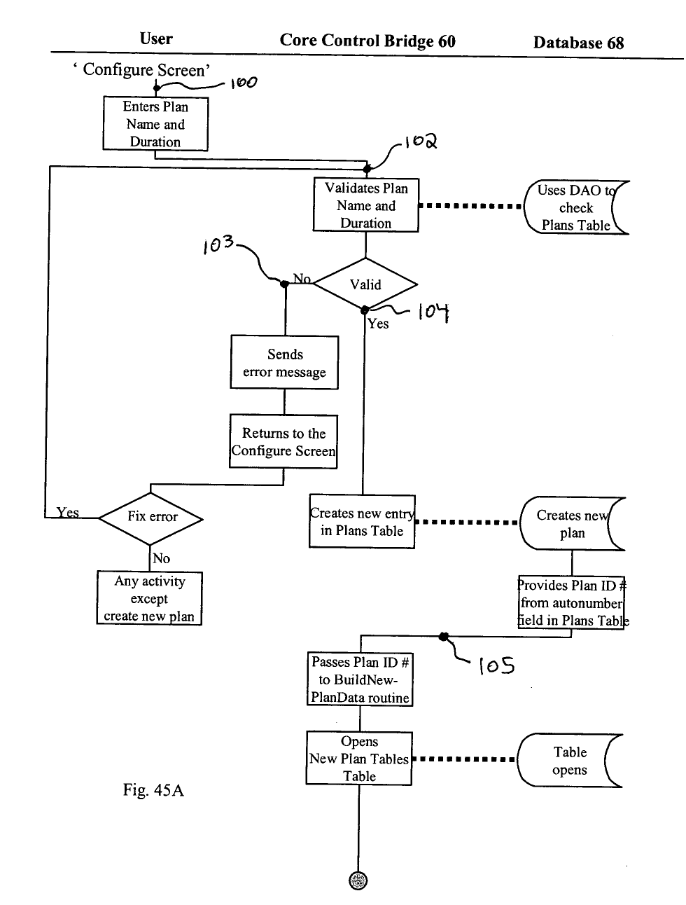

As shown in FIG. 44, the evacuation directive menu 54 contains a list of topics or sub-menus that when opened present the user with a series of screens for compiling the directive. Information derived from the planning menu and stored in the database 68 is parsed and sent to the appropriate screens in each sub-menu. Additional information necessary to complete the directive is collected from the specific submenus and screens.

The CCB 60 generates a directive with the BuildWordDocument routine. This routine accepts three parameters: DocType to specify which directive to build, SaveViewPrint to determine what action to perform after generating the directive, and HeadingOnly, an optional parameter to build only parts of a directive identified as the heading section.

The CCB 60 uses the WordDocumentGeneration table as the control for the BuildWordDocument routine. This table contains the necessary code instructions used to build all directives in the application. These instructions determine which data is transferred to a directive and how that data is to be formatted. The WordDocument Generation table entries are filtered by DocType value to the BuildWordDocument routine and sorted by the Step field. This table also contains fields for Item Type, Table Used, Data, and IsHeading.

The Item Type field is classified into one of the following types: Standard, Repeating, Modified Repeating, Direct, and Code. Standard type is used to insert text followed by a singular field. Repeating type is used to insert text followed by a field or combination of additional text and fields. Modified Repeating is identical in operation to the Repeating type but numbers items as they are created. The Direct type inserts text directly into Microsoft Word. The Code type is used to specify a code routine to process complex data structures.

The Table Used field contains the name of the table or query to be used for each step in building the directive. This field contains an identifier when the Code type is selected to specify a routine to execute. The Data field contains the text and field names to be inserted into the Word Document. Field names are parsed using {and} symbols. The IsHeading field is used to indicate the steps that are part of the heading section of a directive.

When the CCB 60 executes the BuildWordDocument routine, the records from the WordDocumentGeneration table are queried. These records are sorted by step in ascending order, filtered by DocType value and IsHeading value, and passed into the routine.

The CCB 60 opens the Microsoft Word application according to the SaveViewPrint value. At the bottom of the directives menu are two buttons labeled save and view. The save button generates and saves the directive. The view button generates the directive and displays it to the user in Microsoft Word format. Save and Print modes open Microsoft Word hidden in the background. The CCB 60 then opens an empty Microsoft Word document template, executes the BuildWordDocument routine to step through each step of the WordDocumentation Generation record set, and executes the instructions specified by each record. When all steps have been executed, the routine performs formatting and document cleanup.

The final process in the BuildWordDocument routine is to save, view, or print the directive. The SaveViewPrint parameter determines the appropriate action. If the value selected is save, an input box appears containing a default file name to save the directive. The document is saved and Microsoft Word is closed. If the value selected is view, then the Microsoft Word generated document remains on the screen. If the value selected is print, the CCB 60 transmits the document to the printer, prints the document, and closes the Microsoft Word application.

When the user desires to quit the application by selecting any one of the exit buttons, the CCB 60 concludes the Activity routine and executes the Complete parameter. All information entered into the application is automatically saved and available when the program is opened again.

In certain databases, a requirement exists to establish a relationship between the tables of the database and provide a common factor or linkage between these tables. These connections or associations generally occur in databases that contain large numbers of records per table and involve data that is relatively static or unchanging. For example, in corporations with large numbers of employees spread throughout multiple sites, employee information is kept by various departments within the organization and stored in a database on the corporate local area network. A simple table relationship or link can be created that would allow the retrieval of all information concerning a single employee or group of employees from all departments.

In the present invention, generally, there will be a small number of records per table, in many cases, only one. The system can also add records or edit existing records by using various filtering methods. For example, Microsoft Access can use a domain aggregate function as a filtering mechanism. The need to update parts of a plan within the database makes the data in the tables more dynamic and requires the overall program to be more flexible in the manipulation of information.

This required level of flexibility in the invention is not achieved through the use of table relationships or links between tables but through the use of code in the CCB 60. The code programmed into the CCB 60 creates a pseudo-relationship between the various tables of the database 68 for purposes of filtering information and data manipulation and extends to all information management functions in the program. The code routines of the CCB 60 filter, manipulate, and direct the flow of information from the database 68 to the external applications 70 associated with the program, through the necessary file formats 80 to non-compatible programs and systems, to other networks and devices 90, and to the devices serving as an interface with the user.

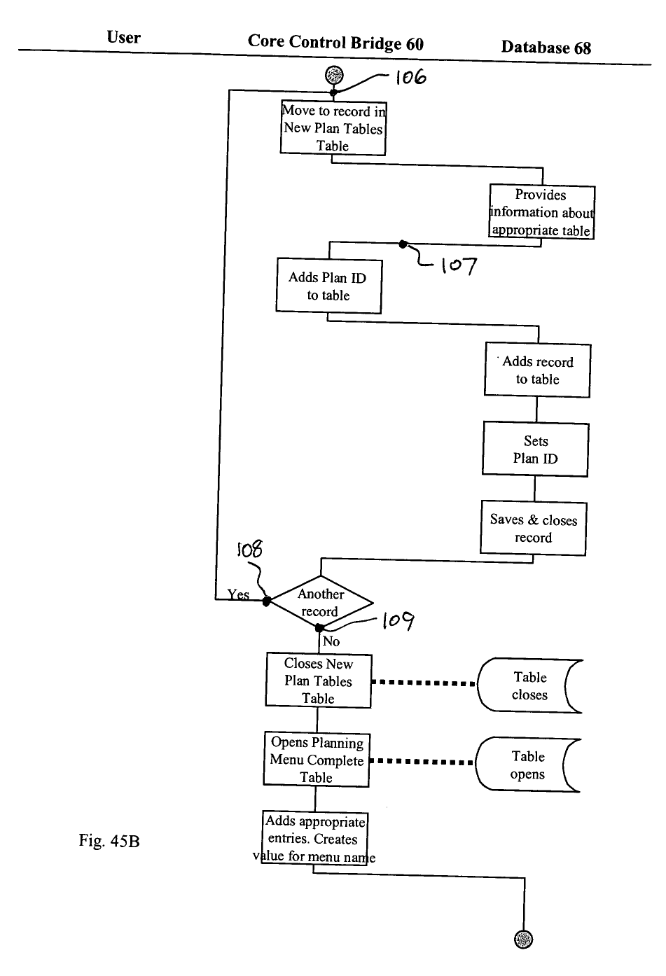

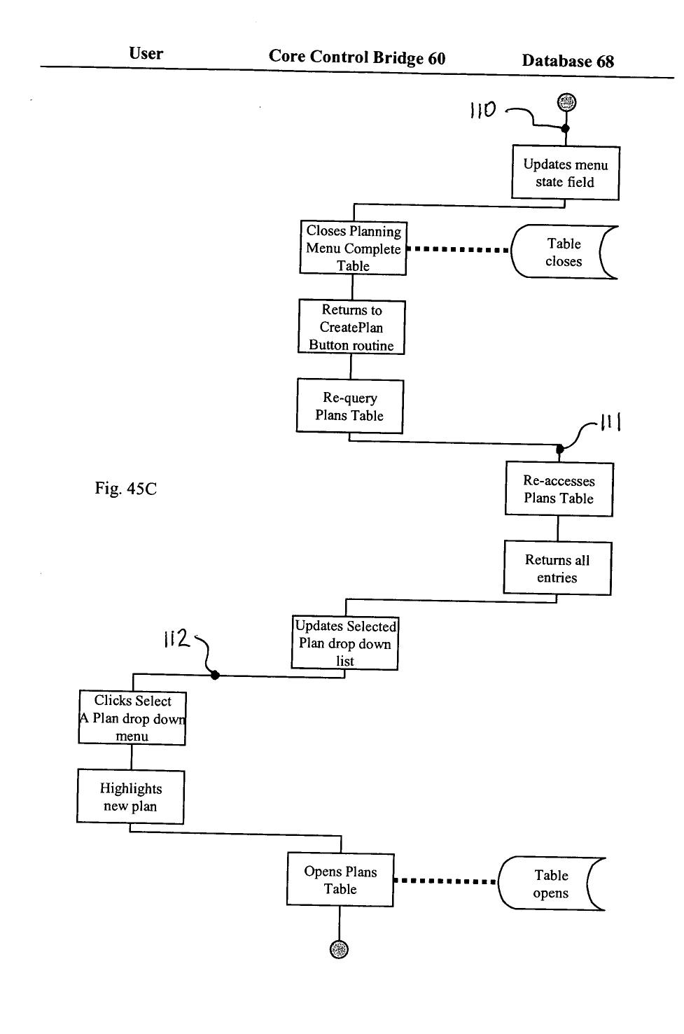

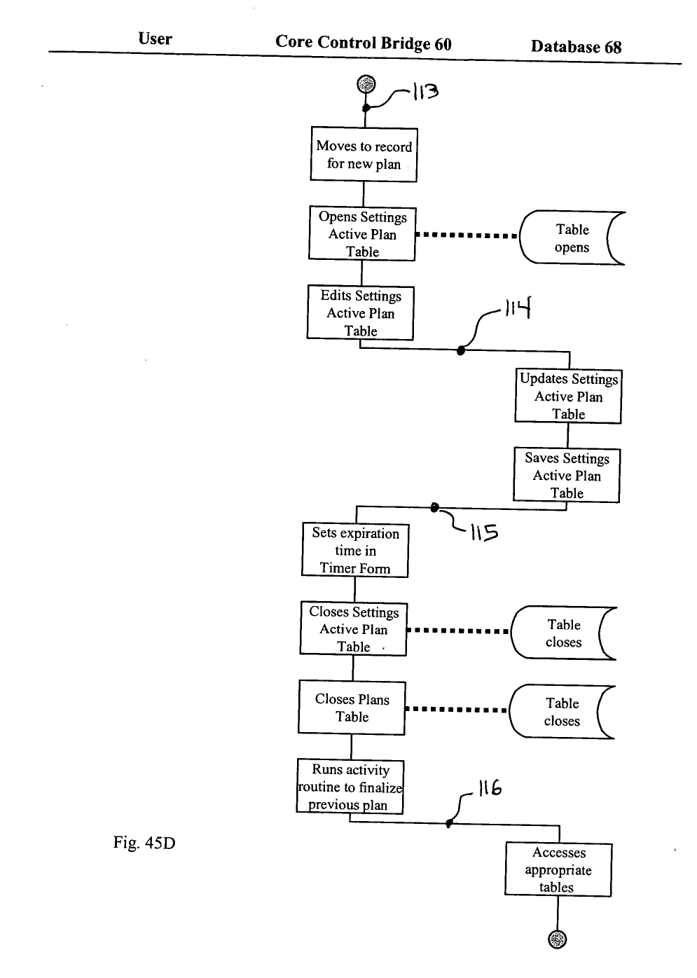

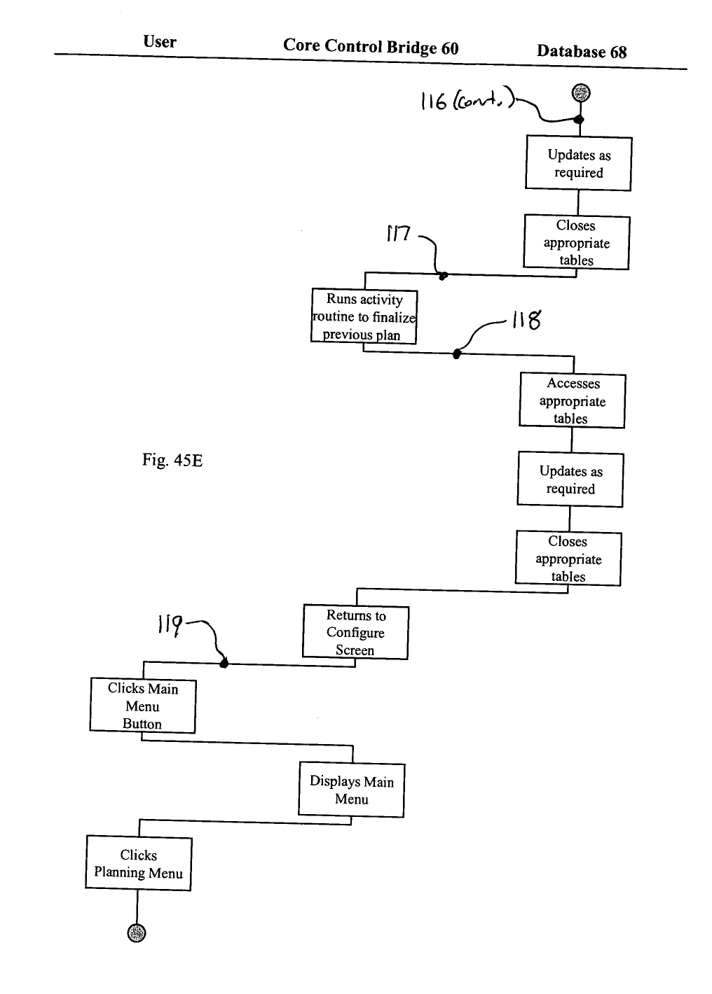

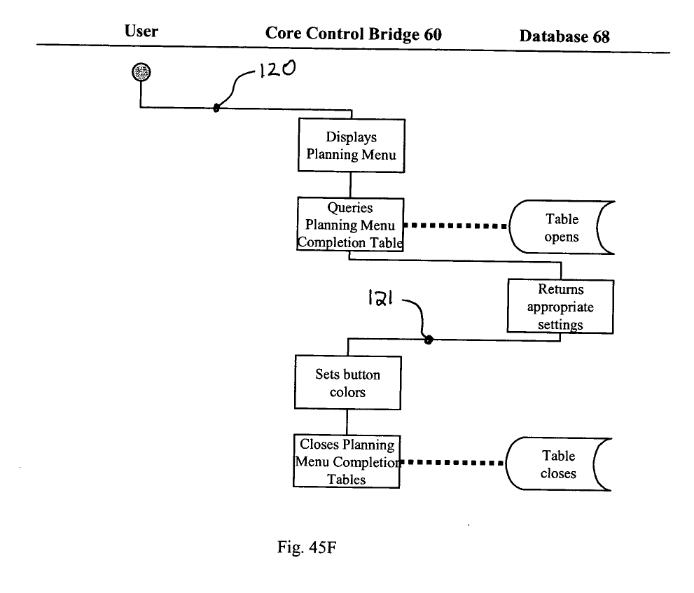

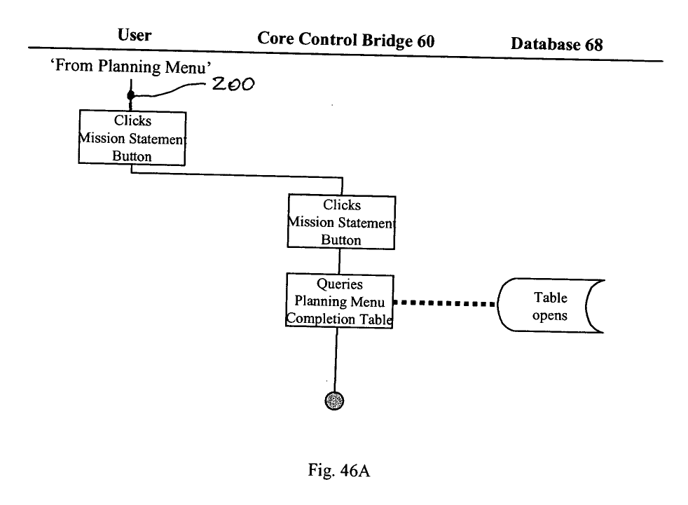

FIG. 45 is a flow diagram depicting an exemplary embodiment of the pseudo-relationships established by the CCB 60 for manipulating the information required for the Microsoft Access based system developed for the city of Middletown. The flow diagram extends across FIGS. 45A-45F, and depicts the flow of information for creating a new plan.

In FIG. 45A, the process starts at Step 100 with the user entering a plan name and duration into the New Plan section of the Configure Screen. The CCB 60 interacts with the database 68 to evaluate and validate the plan name (Step 102), create the new plan, and build all of the required tables for the new plan. The CCB 60 also interacts with the user and becomes the link between the user and the database 68.

If the plan name and duration is invalid, the CCB 60 sends an error message and returns the user to the Configure Screen where the user can opt to fix the error or perform any other task except create a new plan (Step 103). If the plan name and duration is valid, the CCB 60 creates a new entry in the Plans Table and instructs the database 68 to construct the new plan and provide the plan ID number from the auto number field in the Plans Table (Step 104). The CCB 60 then passes the plan ID number to the BuildNewPlanData routine and opens the New Plan Tables Table in conjunction with the database (Step 105).

In FIG. 45B, once in the New Plan Tables Table, the CCB 60 moves to record and prompts the database 68 to provide information about the appropriate table (Step 106). The CCB 60 adds the Plan ID to the table and the database 68 adds records, sets the Plan ID, and saves and closes the record (Step 107). If another record is to be generated, the CCB 60 repeats the process (Step 108). If not, the CCB 60, in conjunction with the database 68, closes the New Plan Tables Table and opens the Planning Menu Complete Table. The CCB 60 then adds the appropriate entries and creates a value for the menu name (Step 109).

In FIG. 45C, the database 68 updates the menu state field and, when complete, the CCB 60 closes the Planning Menu Complete Table, returns to the CreatePlan Button routine to re-query the Plans Table (Step 110). The database 68 re-assesses the Plans Table and returns all entries to the CCB 60 to update the Selected Plan drop down list (Step 111). The user can then access the new plan by clicking the Select a Plan drop down menu on the Configure Screen. The user highlights the new plan and the CCB 60 opens the Plans Table with the database (Step 112).

In FIG. 45D, the CCB 60 then moves to the record for the new plan and opens the Settings Active Plan Table in the database 68 and edits the Settings Active Plan Table (Step 113). The database 68 updates the Settings Active Plan Table and saves the data (Step 114). The CCB 60 then sets the expiration time in the Timer Form, closes the Settings Active Plan Table and the Plans Table in the database 68 and runs the activity routine to finalize any previous planning efforts (Step 115).

In FIGS. 45D and 45E, the database 68 accesses the appropriate tables, updates them as required, and closes these tables (Step 116). The CCB 60 then runs the activity routine once again to close out previous plans (Step 117). The database 68 re-accesses the tables, updates as required, and closes the tables. The CCB 60 returns the user to the Configure Screen (Step 118). The user enters the Main Menu and the CCB 60 displays this menu. The user then opens the Planning Menu (Step 119).

In FIG. 45F, the CCB 60 displays the Planning Menu and queries the Planning Menu Completion Table in the database 68 for the proper settings (Step 120). The CCB 60 then sets the button colors and closes the Planning Menu Complete Tables in the database 68. The new plan is now displayed for the user (Step 121).

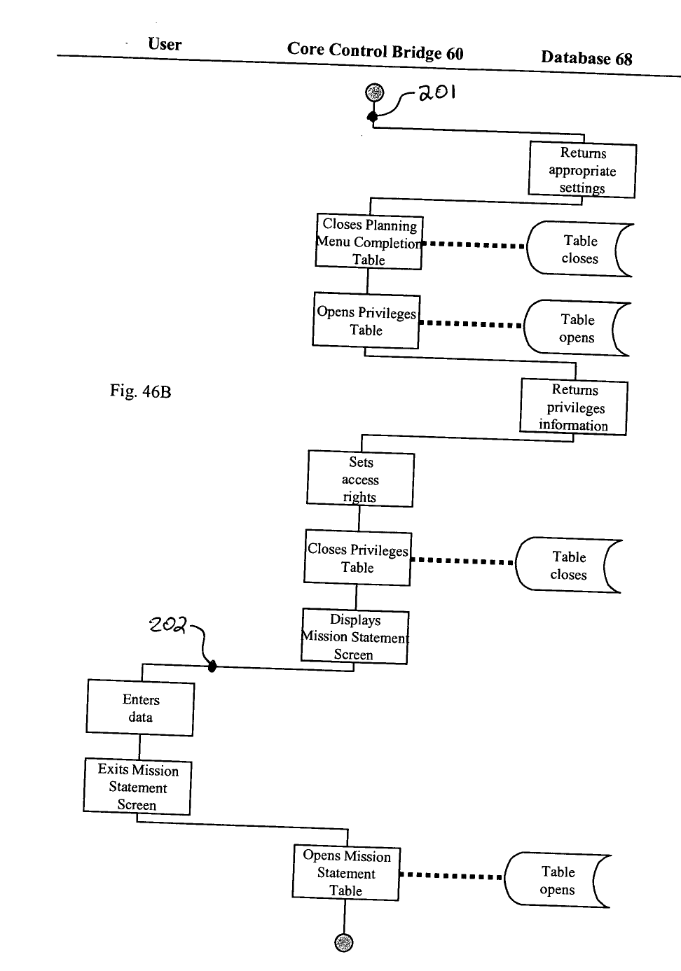

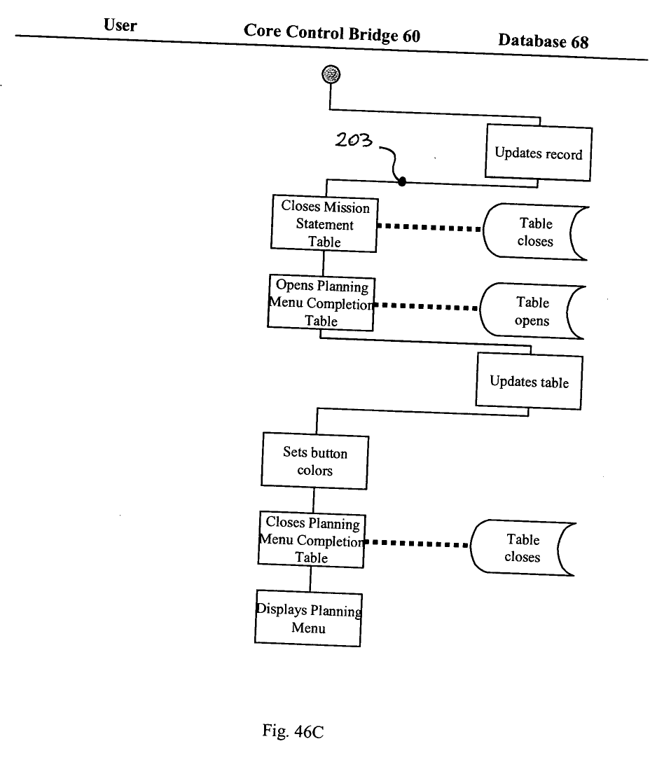

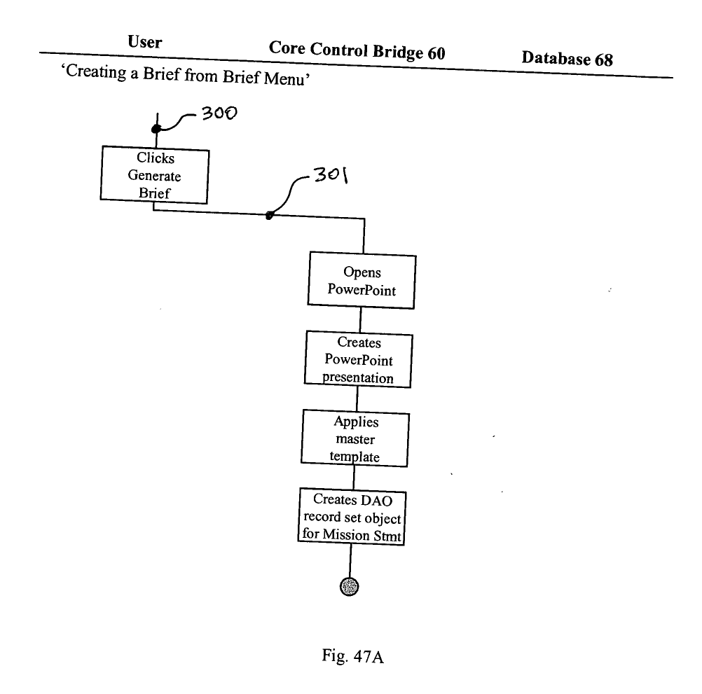

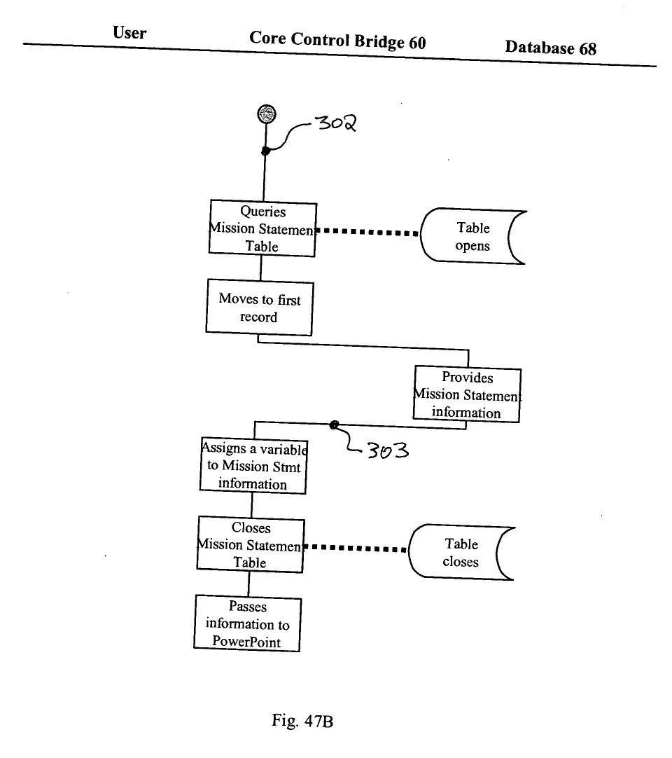

Once a new plan has been created, the user can begin the data entry process. FIGS. 46A-46C demonstrate the relationships between the user, the CCB 60, and the database 68 for data input of the Mission Statement sub-menu of the Planning Menu. In the invention, most records within each table are created when the plan itself is created. The Mission Statement Table has a mission statement record that already exists when the user elects to input data. This record is filtered in Microsoft Access by using the Plan ID Number that was generated within the Plans Table. In this example, the mission statement requires certain administrative privileges to enter and edit data. These privileges are enforced by the CCB 60 through information retrieved from the Privileges Table of the database 68.

In FIG. 46A, the user decides to enter data into the Mission Statement section of the new plan and clicks the Mission Statement button. The CCB 60 acknowledges the Mission Statement button and queries the Planning Menu Completion Table in the database (Step 200).

In FIG. 46B, the database 68 returns the appropriate settings and the Planning Menu Complete Table is closed. The CCB 60 then opens the Privileges Table and queries the database 68 to determine if the user is authorized into that section. The database 68 returns the privileges information and the CCB 60 sets the access rights for the user, closes the Privileges Table, and displays the Mission Statement screen (Step 201).

The user enters the data as required and exits the Mission Statement screen. The CCB 60 opens the Mission Statement Table and the database 68 updates the record (Step 202).

In FIG. 46C, the CCB 60 then closes the Mission Statement Table and opens the Planning Menu Completion Table. The database 68 updates this table and the CCB 60 sets the appropriate button color. The CCB 60 then closes the Planning Menu Completion Table and displays the Planning Menu for the user (Step 203).

FIGS. 47A and 47B illustrate an example of how the CCB 60 interacts with the user and the database 68 to create an external application. In this example, the external application is a PowerPoint presentation. The flow chart depicts the steps to populate a PowerPoint slide for the mission statement discussed above.

In FIG. 47A, the user has elected to create a brief from the Brief Menu and clicks the Generate Brief button (Step 300). The CCB 60 opens PowerPoint and creates a PowerPoint presentation, applies the master template to the brief, and creates a DAO record set object for Mission Statement (Step 301).

In FIG. 47B, the CCB 60 then queries the Mission Statement Table in the database 68 and moves to the appropriate record. The database 68 provides the Mission Statement information (Step 302). The CCB 60 then assigns a variable to the Mission Statement information and closes the Mission Statement Table in the database 68. The CCB 60 then passes the information to the PowerPoint presentation and the information is added to the brief (Step 303).

Although the example used in this presentation was specific to Microsoft Access, the procedures would be similar for other programming languages. As with Microsoft Access, if the customer's requirements call for the use of a Sequential Query Language (SQL) database server with ActiveX Data Objects (ADO), the small number of records in each table and the need to add and update information to the database would also limit the use of conventional table relationships and links.

The present invention anticipates the continued evolution in software development, hardware and other computer peripherals, and operating systems. The CCB 60 of the invention is designed to be capable of adapting to meet future development and modifications to existing hardware, software, and operating systems.

While the present invention has been described in detail with reference to the preferred embodiments thereof, it should be understood to those skilled in the art that various changes, substitutions and alterations can be made hereto without departing from the scope of the invention as defined by the appended claims.

What is claimed is:

1. A planning support method implemented in a computer system having a core control bridge communicating between a database and a user interface, the method comprising:
receiving by the core control bridge, user inputs from the user interface in accordance with criteria specified by a pre-existing planning model stored in the database;
processing information from the user inputs in accordance with the criteria of the pre-existing planning model;
preparing export file formats for exporting information, the information being determined by interaction between the user inputs and the criteria of the pre-existing planning model; and
exporting the information in accordance with the export file format.

2. The planning support method of claim 1, wherein the receiving step comprises receiving user inputs from other users connected to the core control bridge to facilitate collaborative planning.

3. The planning support method of claim 2, wherein the other users access the core bridge through a communication link accessing a centralized core control bridge and a centralized database.

4. The planning support method of claim 2, wherein the other users access the core bridge through a communication link between a distributed core control bridge and a centralized database.

5. The planning support method of claim 2, wherein the preparing step is performed automatically by the core control bridge.

6. The planning support method of claim 5, wherein the preparing step further comprises generating export file formats compatible with commercially available software applications as defined by the pre-existing planning model.

7. The planning support method of claim 6, wherein the generating step includes generating export file formats compatible with word processing software, graphics and presentation software, and global computing network, formats.

8. The planning support method of claim 5, wherein the preparing step further comprises generating export file formats compatible with commercially available computer hardware and communication systems as defined by the pre-existing planning model.

9. The planning support method of claim 5, wherein the preparing step further comprises generating export file formats that are customized for compatibility with a proprietary software application as defined by the pre-existing planning model.

10. The planning support method of claim 5, wherein the preparing step further comprises generating export file formats that are customized for compatibility with proprietary computer hardware and communication systems as defined by the pre-existing planning model.

11. The planning support method of claim 5, wherein the preparing step further comprises generating export file formats that are customized for compatibility with an operating system different than an operating system running the core control bridge.

12. A computerized planning support system, comprising:
means for receiving user inputs from the user interface in accordance with criteria specified by a pre-existing planning model stored in a database;
means for processing information from the user inputs in accordance with the criteria of the pre-existing planning model;
means for preparing export file formats for exporting information, the information being determined by interaction between the user inputs and the criteria of the pre-existing planning model; and
means for exporting the information in accordance with the export file format.

13. The planning support method of claim 12, further comprising means for generating export file formats compatible with commercially available software applications as defined by the pre-existing planning model.

14. The planning support method of claim 12, further comprising means for generating export file formats compatible with proprietary software applications as defined by the pre-existing planning model.

15. A planning support system, comprising:
a database resident on the computer system;
a user interface for interfacing with the database;
a pre-existing planning model stored in the database;
a core control bridge resident on the computer system, the core control bridge communicating between the database and the user interface;
means for receiving by the core control bridge, user inputs from the user interface in accordance with criteria specified by a pre-existing planning model stored in the database;
means for processing information from the user inputs in accordance with the criteria of the pre-existing planning model;
means for preparing export file formats for exporting information, the information being determined by interaction between the user inputs and the criteria of the pre-existing planning model; and
means for exporting the information in accordance with the export file format.

16. The planning support method of claim 15, further comprising means for generating export file formats compatible with commercially available software applications as defined by the pre-existing planning model.

17. The planning support method of claim 15, further comprising means for generating export file formats compatible with customized software applications as defined by the pre-existing planning model.
